(19) United States
(12) Patent Application Publication
(10) Pub. No.: US 2024/0346415 A1
(43) Pub. Date: Oct. 17, 2024

(54) LOCATION AND MARKING SYSTEM AND SERVER

(71) Applicant: PACIFIC GAS AND ELECTRIC COMPANY, San Francisco, CA (US)

(72) Inventors: Shelbey Warner, San Francisco, CA (US); Michael Robert Wolf, Oakland, CA (US); Billy Dean Glenn, Martinez, CA (US); Michael Hansen, Paso Robles, CA (US); Morgan Sharif, San Francisco, CA (US); Jason Klemm, Concord, CA (US); Zachary Scofield, San Jose, CA (US); Edward Dotson, San Jose, CA (US); Travis Huston, San Jose, CA (US); Steven Walker, Grass Valley, CA (US); Michael S. Glass, Oakland, CA (US); Patrick Buckles, San Ramon, CA (US); Tony Chen, San Francisco, CA (US); Sivakrishna Jasti, Newark, CA (US)

(21) Appl. No.: 18/419,524

(22) Filed: Jan. 22, 2024

Related U.S. Application Data
(63) Continuation of application No. 17/688,595, filed on Mar. 7, 2022, now abandoned.
Application No. 17/688,595 is a continuation of application No. 16/932,044, filed on Jul. 17, 2020, now abandoned.
(60) Provisional application No. 62/875,435, filed on Jul. 17, 2019.

(51) Int. Cl. G06Q 10/0631; G06Q 10/0637; G06Q 50/06

(52) U.S. Cl. CPC G06Q 10/06315; G06Q 10/06314; G06Q 10/0637; G06Q 50/06

(57) ABSTRACT

A novel location and marking system is configured to provide a seamless in-the-field access to resource and asset information databases with automated functionality that effectively and more efficiently manages, controls, and distributes data according to some embodiments. In some embodiments, such systems can enable utilities to manage assets in real-time, provide map asset status, and provide automatic ticket routing, dispatching and management. For example, in some embodiments, the system is configured to generate maps with identifiers or components of an active division including tickets of one or more assets of an active division. These assets include sites of residential and business gas, electrical, and/or water and sewer conduits and metering systems, as well as related underground infrastructure that can be susceptible to earthquakes, ground disturbances, and other emergency situations according to some embodiments.

### CROSS-REFERENCE TO RELATED APPLICATIONS

This application is a continuation of U.S. patent application Ser. No. 17/688,595, filed Mar. 7, 2022, entitled “Location and Marking System and Server”, which is a continuation of U.S. patent application Ser. No. 16/932,044, filed Jul. 17, 2020, entitled “Location and Marking System and Server”, which claims the benefit of and priority to U.S. Provisional Application No. 62/875,435, filed Jul. 17, 2019, entitled “Location and Marking System and Server”, the entire contents of which are incorporated herein by reference.

### BACKGROUND

Utility workers and supervisors strive to maintain efficient and safe working practices in spite of the volume of information sources, the way in which this information is reviewed and exchanged, and the use of processes that are encumbered by manual procedures. These issues can become especially acute when attempting to address emergency or evacuation situations.

Accordingly, there is a need to provide a seamless in-the-field access to resource and asset information databases with automated functionality that effectively and more efficiently manages, controls, and distributes data. Such systems could enable utilities to manage assets in real-time, provide map asset status, and provide automatic ticket routing, dispatching and management. For example, the system could generate maps with identifiers or components of an active division including tickets of one or more assets of an active division. These assets could include sites of residential and business gas, electrical, and/or water and sewer conduits and metering systems, as well as related underground infrastructure that can be susceptible to earthquakes, ground disturbances, and other emergency situations.

### SUMMARY

Some embodiments of present disclosure provide various exemplary technically improved computer-implemented platforms, systems and methods, including methods for providing a seamless in-the-field access to resource and asset information databases with automated functionality that effectively and more efficiently manages, controls, and distributes data such as: receiving location information data associated with one or more assets; generating one or more maps based on the location information data; displaying the one or more maps through a graphical user interface provided by the computing device, where each map covers at least a portion of the one or more assets; receiving an input from the user to select one or more map types based on the one or more assets; and displaying the one or more selected map types to the user. [0005] In some embodiments, the system includes a location and marking system configured to be in electronic communication with a plurality of users, the location and marking system comprising a non-transitory computer-readable program memory storing instructions, a non-transitory computer-readable data memory, and a processor configured to execute the instructions. The processor is configured to execute the instructions to receive location information data associated with one or more assets; generate one or more maps based on the location information data; display the one or more maps through a graphical user interface, where each map covers at least a portion of the one or more assets; receive an input to select one or more map types based on the one or more assets; and display the one or more selected map types.

In other embodiments, the system comprises a non-transitory computer-readable medium including one or more sequences of instructions that, when executed by one or more processors, cause the performance of the following operations: receiving location information data associated with one or more assets; generating one or more maps based on the location information data; displaying the one or more maps through a graphical user interface provided by the computing device, each map covering at least a portion of the one or more assets; receiving an input from the user to select one or more map types based on the one or more assets; and displaying the one or more selected map types to the user.

### DESCRIPTION OF THE DRAWINGS

FIG. 1 illustrates a location application display page generated by the location and marking system according to some embodiments.

FIG. 2 illustrates a supervisor user interface generated by the location and marking system according to some embodiments.

FIG. 3 illustrates a map with ticket marker display page generated by the location and marking system according to some embodiments.

FIG. 4 illustrates a map with gas distribution display page generated by the location and marking system according to some embodiments.

FIG. 5 illustrates mobile information display page generated by the location and marking system according to some embodiments.

FIG. 6 illustrates service location and location GSR data displays generated by the location and marking system according to some embodiments.

FIG. 7 illustrates a ticket information display generated by the location and marking system according to some embodiments.

FIG. 8 illustrates a map information display generated by the location and marking system according to some embodiments.

FIG. 9 illustrates user mobile display pages generated by the location and marking system according to some embodiments.

FIG. 10 illustrates a dashboard folder view generated by the location and marking system according to some embodiments.

FIG. 11 illustrates a ticket list with map search display generated by the location and marking system according to some embodiments.

FIG. 12 illustrates example locate forms generated by the location and marking system according to some embodiments.

FIG. 13 illustrates supervisor user interface functions generated by the location and marking system according to some embodiments.

FIG. 14 illustrates a ticket-list split screen generated by the location and marking system according to some embodiments.

FIGS. 15-17 illustrate real-time dashboard displays generated by the location and marking system according to some embodiments.

FIG. 18 illustrates a ticket list display generated by the location and marking system according to some embodiments.

FIGS. 19-24 illustrate ticket selected displays generated by the location and marking system according to some embodiments.

FIGS. 25-26 illustrate reassign ticket displays generated by the location and marking system according to some embodiments.

FIGS. 27-28 illustrate performance display pages generated by the location and marking system according to some embodiments.

FIG. 29 illustrates a real-time dashboard display page generated by the location and marking system according to some embodiments.

FIG. 30 illustrates reassign ticket display generated by the location and marking system according to some embodiments.

FIGS. 31-34 illustrate active real-time dashboard displays generated by the location and marking system according to some embodiments.

FIGS. 35-36 illustrate real-time dashboard displays generated by the location and marking system according to some embodiments.

FIG. 37 illustrates a map view display generated by the location and marking system according to some embodiments.

FIG. 38 illustrates a ticket view display generated by the location and marking system according to some embodiments.

FIGS. 39-40 illustrate ticket and map displays generated by the location and marking system according to some embodiments.

FIG. 41 illustrates reassign ticket displays generated by the location and marking system according to some embodiments.

FIG. 42 illustrates an order summary display generated by the location and marking system according to some embodiments.

FIG. 43 illustrates a ticket and order detail display generated by the location and marking system according to some embodiments.

FIGS. 44-45 illustrate closing soon displays generated by the location and marking system according to some embodiments.

FIG. 46 illustrates a “tickets closing soon” list display generated by the location and marking system according to some embodiments.

FIG. 47 illustrates a computer system enabling systems and methods in accordance with some embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. Some embodiments of the system are configured to be combined with some other embodiments and all embodiments are capable of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use the system. Various modifications to the illustrated embodiments will be readily apparent to those skilled in the art, and the generic principles recited according to some illustrated embodiments are configured to be applied to and/or combined with some other illustrated embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Some embodiments of the invention include various methods, apparatuses (including computer systems) that perform such methods, and computer readable media containing instructions that, when executed by computing systems, cause the computing systems to perform such methods. For example, some non-limiting embodiments comprise certain software instructions or program logic stored on one or more non-transitory computer-readable storage devices that tangibly store program logic for execution by one or more processors of the system and/or one or more processors coupled to the system.

Some embodiments relate to improved data processing in electronic devices including, for example, an entity or machine such as a location and marking execution system that provides a technological solution where users can more efficiently process and view and/or retrieve useful data based on improvements in capturing and manipulating utilization, job history, and job hour history data. For example, some embodiments generally describe non-conventional approaches for systems and methods that capture, manipulate utilization, job history, and job hour history data that are not well-known, and further, are not taught or suggested by any known conventional methods or systems. Moreover, in some embodiments, the specific functional features are a significant technological improvement over conventional methods and systems, including at least the operation and functioning of a computing system that are technological improvements. In some embodiments, these technological improvements include one or more aspects of the systems and method described herein that describe the specifics of how a machine operates, which the Federal Circuit makes clear is the essence of statutory subject matter.

Some embodiments described herein include functional limitations that cooperate in an ordered combination to transform the operation of a data repository in a way that improves the problem of data storage and updating of databases that previously existed. In particular, some embodiments described herein include system and methods for managing single or multiple content data items across disparate sources or applications that create a problem for users of such systems and services, and where maintaining reliable control over distributed information is difficult or impossible.

The description herein further describes some embodiments that provide novel features that improve the performance of communication and software, systems and servers by providing automated functionality that effectively and more efficiently manages resources and asset data for a user in a way that cannot effectively be done manually. Therefore, the person of ordinary skill can easily recognize that these functions provide the automated functionality, as described herein according to some embodiments, in a manner that is not well-known, and certainly not conventional. As such, some embodiments of the invention described herein are not directed to an abstract idea and further provide significantly more tangible innovation. Moreover, the functionalities described herein according to some embodiments were not imaginable in previously-existing computing systems, and did not exist until some embodiments of the invention solved the technical problem described earlier.

Some embodiments include a location and marking system with improved usability, safety, quality, and performance for locators over conventional methods. In some embodiments, some quality related metrics of the system include, but are not limited to, at least one or more of the following: global reset signal (“GSR”) capability, as-builts available in the system application, standard work processes reinforced and improved through a user-interface, image and/or video upload capability, priority ticket visibility (e.g. overdue, due soon tickets), historical ticket information and field intelligence, instrument calibration verification, operator qualification verification, a safety related metrics, emergency ticket visibility, field intelligence, training access, ticket enrichment including risk score, and unitization.

Some embodiments include a system comprising operations for retrieving location or Global Positioning System (GPS) position data from at least one coupled or integrated asset, and retrieving at least one map and/or image from a mapping component of the system representing at least one asset location. Further, based at least in part on the location or GPS position data, the system is configured to display at least one map or map image including a representation of the asset in a position on the map image based at least in part on the actual physical location of the asset according to some embodiments. In some embodiments, the system is configured to generate and display the map (e.g., covering at least a portion of one or more asset or infrastructure service areas) on a display, such as a graphical user interface (GUI) provided by one or more user devices. In some embodiments, the map can include one or more identifiers or components of an active division. In some embodiments, the map is configured to include one or more tickets pending or issued to one or more assets of an active division. In some embodiments, the system is configured to allow a user to select an active division to enable the system to selectively display one or more assets such as gas distribution assets, gas transmission assets, and/or electrical distribution assets. In some embodiments, assets include sites of residential and business gas conduits and/or metering systems, as well as other underground systems.

Some embodiments include a display of an activity or ticket log. For example, in some embodiments, one or more user displays are configured to display the activity of one or more users. In some embodiments, the log comprises a date and time of one or more activities of one or more users.

In some embodiments, the system comprises program logic enabling a map manager that is configured to select or define a map type based on one or more assets, infrastructure, or a service provided. For example, in some embodiments, an interface of the system is configured to select one or more of a gas distribution map type, a gas transmission map type, an electrical distribution map type, an electrical transmission map type, a hydroelectric map type, and/or a fiber map type. In some embodiments, the system is configured to enable a user to also select a desired division for display as at least a portion of a displayed map upon a a user's selection of the gas distribution map type, a gas transmission map type, an electrical distribution map type, an electrical transmission map type, a hydroelectric map type, and/or a fiber map type.

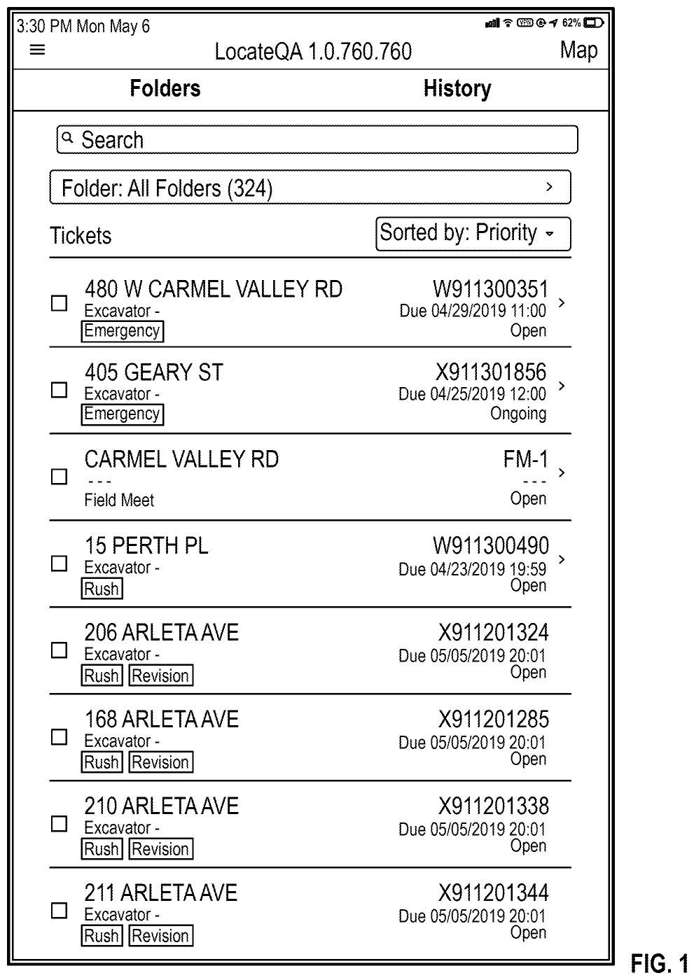

In some embodiments, the system includes a location application with access to location folders and history. For example, FIG. 1 illustrates a location application display page generated by the location and marking system according to some embodiments. In some embodiments, the display can comprise a list of one or more open or active tickets. For example, some embodiments include a location address and/or business name, a description of the tooling and/or asset, a status (such as emergency, rush, etc.), an assigned ID, a due date, and/or an open status. In some embodiments, the display is configured to be sorted or filtered. For example, in some embodiments, the display results or content are configured to be sorted by priority.

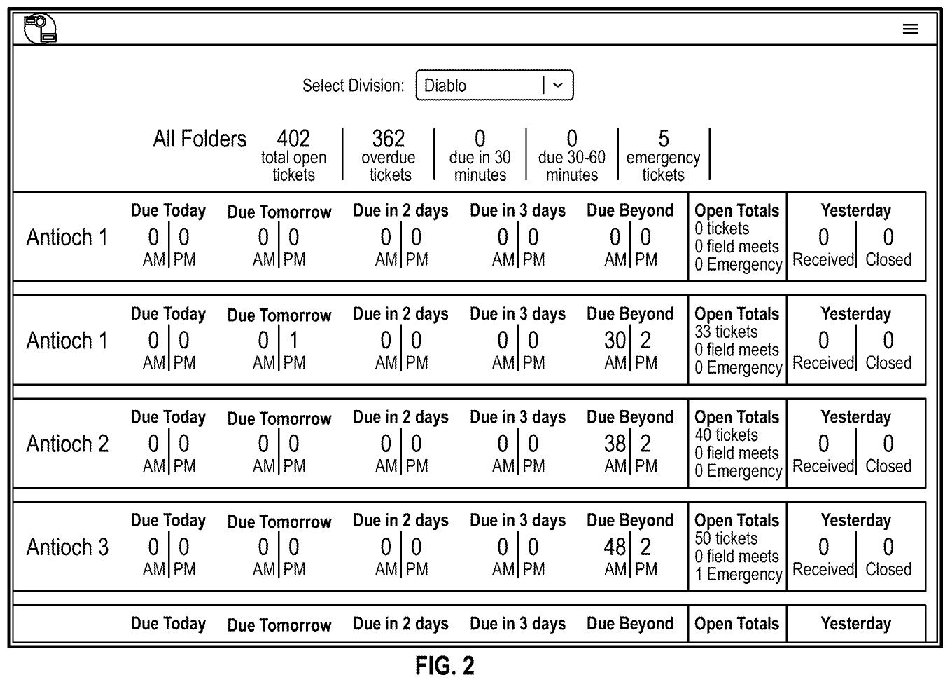

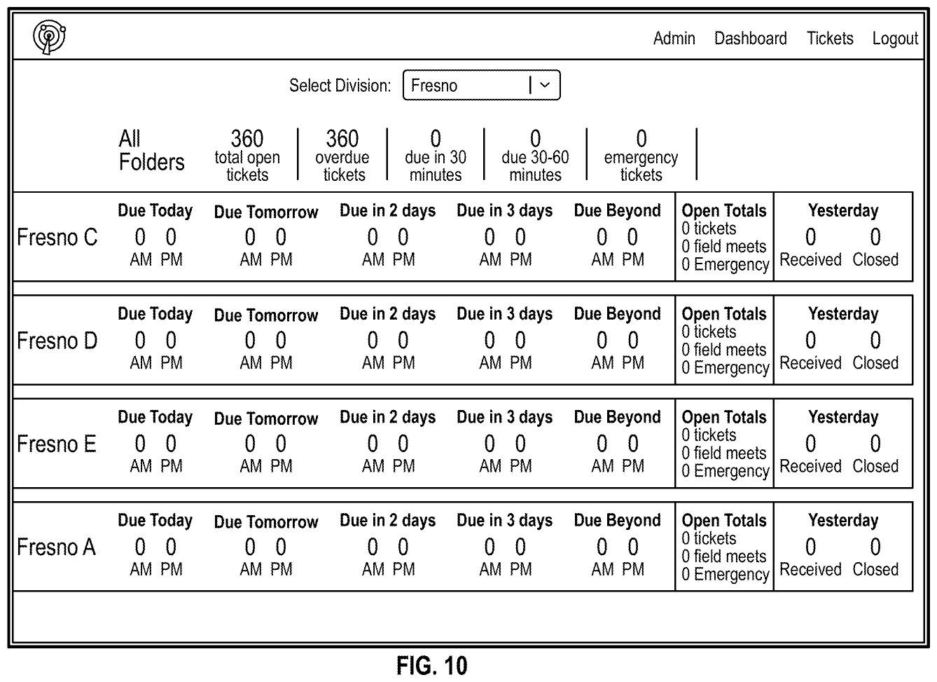

In some embodiments, the system is configured to generate a user interface for use by a manager or supervisor. In some embodiments, the interface is configured to enable seamless management of tickets and/or locator workload. For example, FIGS. 2 and 10 illustrate a supervisor user interface generated by the location and marking system according to some embodiments. In some embodiments, the user interface is configured to include a display of ticket statistics, including, but not limited to, total open tickets, overdue tickets, tickets due in 30 minutes, tickets due in 30 to 60 minutes, and/or the number of emergency tickets. Further, the display is configured to comprise a list of tickets due including, but not limited to one or more of: statistics for due today, due tomorrow, due in two days, due in three days, and/or due beyond; and/or open tickets including one or more of: tickets, field meets, emergency, and tickets received yesterday including those received and/or closed.

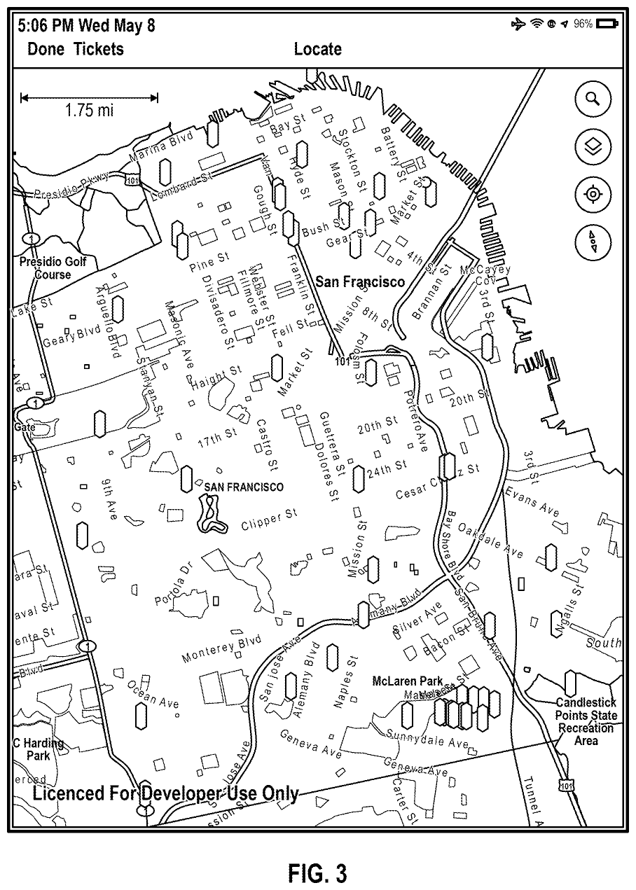

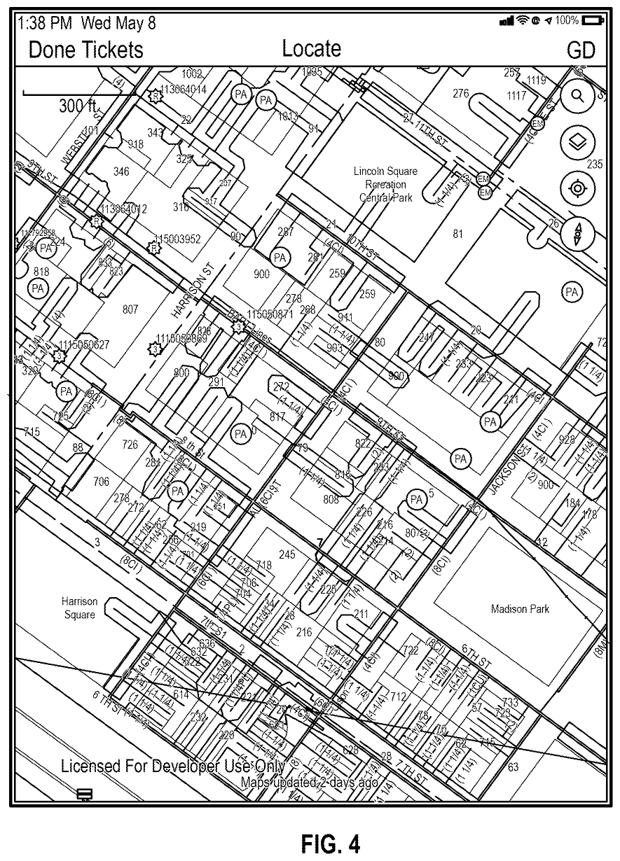

Some embodiments include a locate application that includes visual features to improve the locator experience. For example, FIG. 3 illustrates a map with a ticket marker display page generated by the location and marking system according to some embodiments. FIG. 4 illustrates a map with gas distribution display page generated by the location and marking system according to some embodiments. Some embodiments include a water distribution display, fuel distribution display, and any distributable resource display.

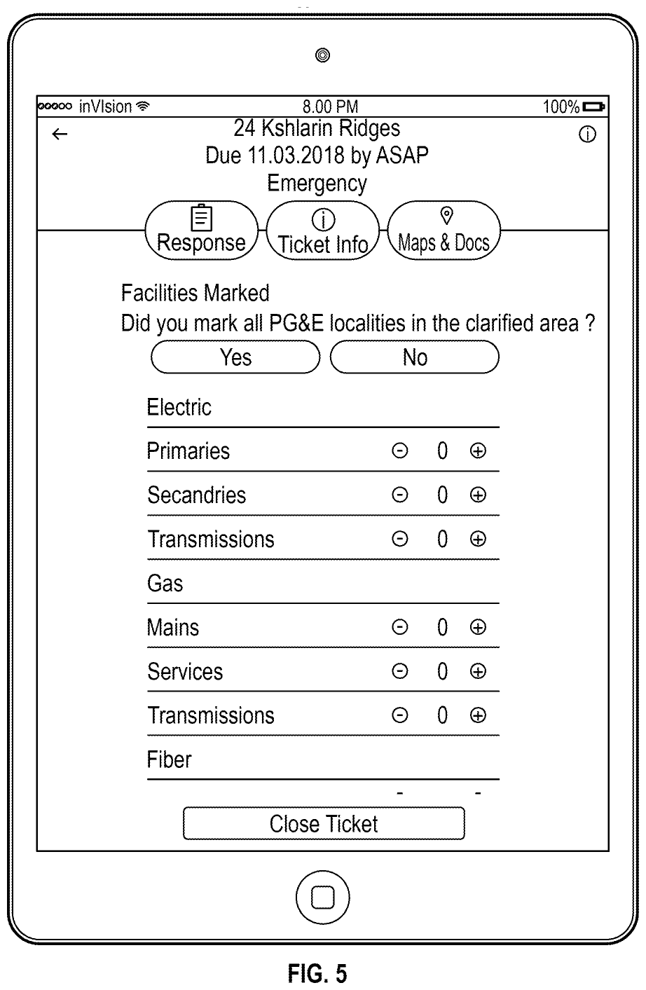

Some embodiments include displays, such as information displays for mobile devices such as tablets and mobile phones. In some embodiments, the displays are configured to enable an operator to enter information regarding a resource location, site, and/or an on-going emergency as the resource location or site. For example, FIG. 5 illustrates mobile information display page generated by the location and marking system according to some embodiments. In some embodiments, the display is configured to enable one or more of an entry of response and ticket information, entry of information related to assets at the location, and/or retrieval or maps and other documents related to the asset.

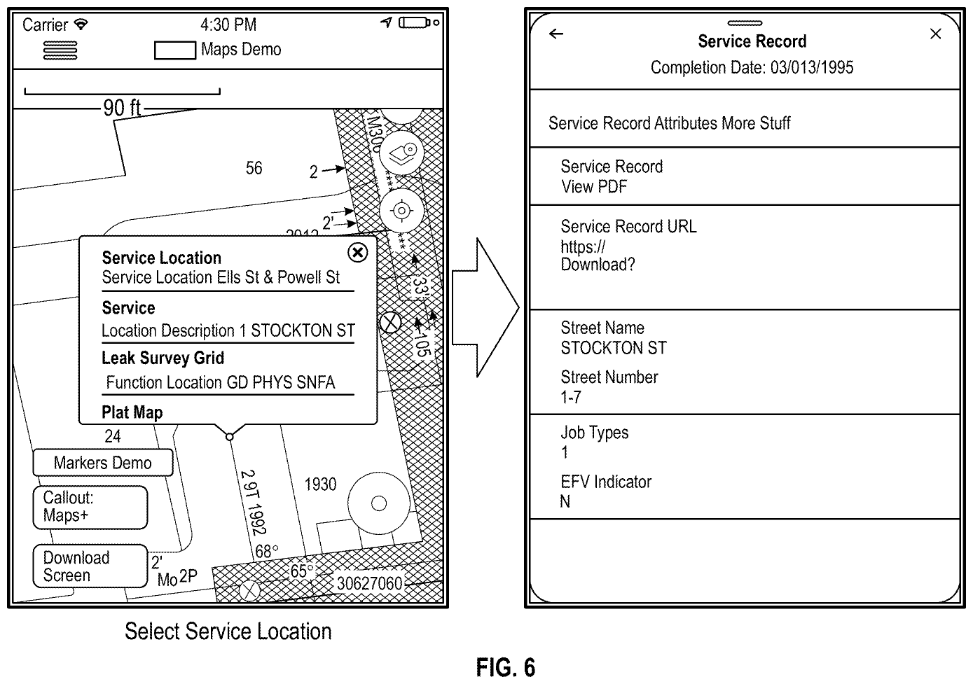

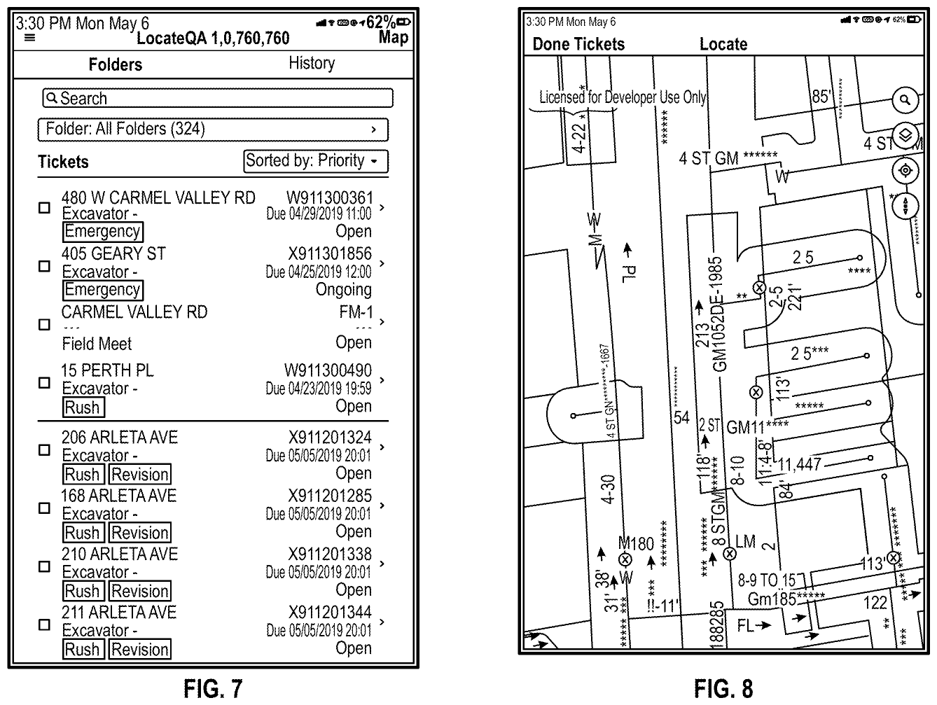

In some embodiments, the system is configured to provide service and asset location and mapping features. In some embodiments, the system is configured to display a map for selection of a service location. In some further embodiments, the system is configured to view location GSR data. For example, FIG. 6 illustrates service location and location GSR data displays generated by the location and marking system according to some embodiments. In some embodiments, the system is configured to automatically map one or more assets, and any associated tickets identifying where and when work is scheduled and/or completed. In some embodiments, the system is configured to display street-level data and/or satellite imagery layers. Further examples are shown in FIG. 7, illustrating a ticket information display generated by the location and marking system according to some embodiments, and FIG. 8 illustrates a map information display generated by the location and marking system according to some embodiments.

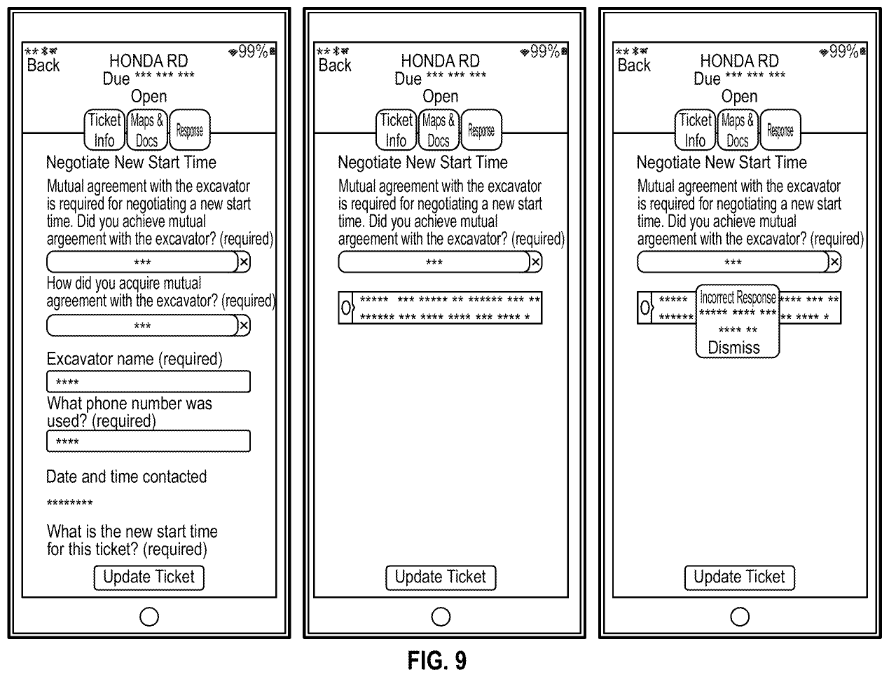

In some embodiments, the system is configured to enable a user-interface providing ticket update features enabling a user to rapidly review and update a ticket. For example, FIG. 9 illustrates user mobile display pages generated by the location and marking system according to some embodiments. In some embodiments, the interface is configured to enable a user to modify a time (e.g., a start time), and/or enable communication with an excavator.

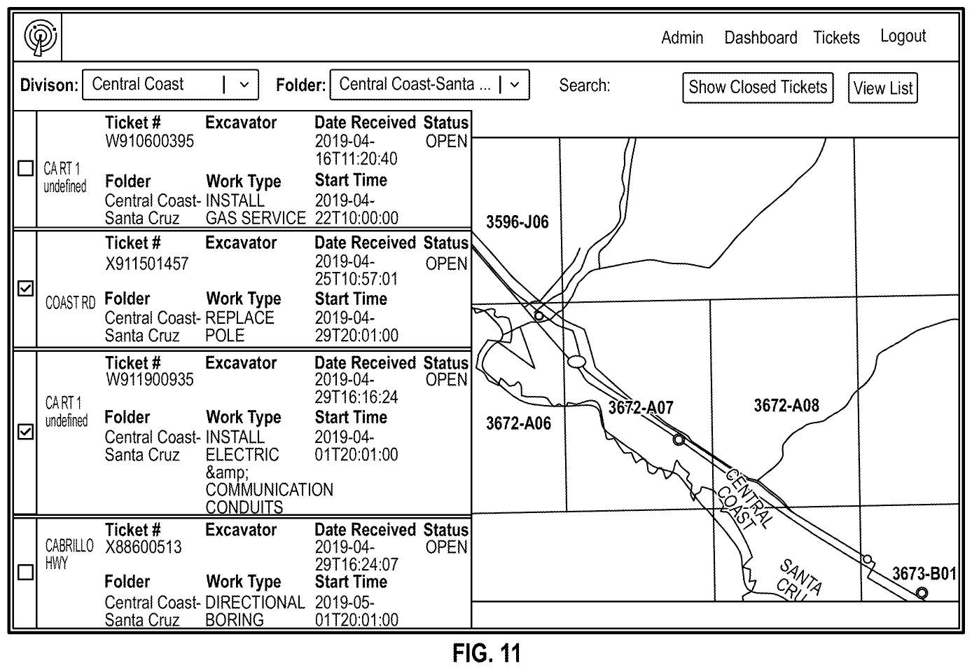

FIG. 11 illustrates a ticket list with map search display generated by the location and marking system according to some embodiments. As shown, in some embodiments, the system is configured to display tickets of a selected division on one side of the display, and/or a map of at least a portion of the division on the opposite side of the display. In some embodiments, at least one parameter of the ticket and/or location of the ticket can be displayed on the map.

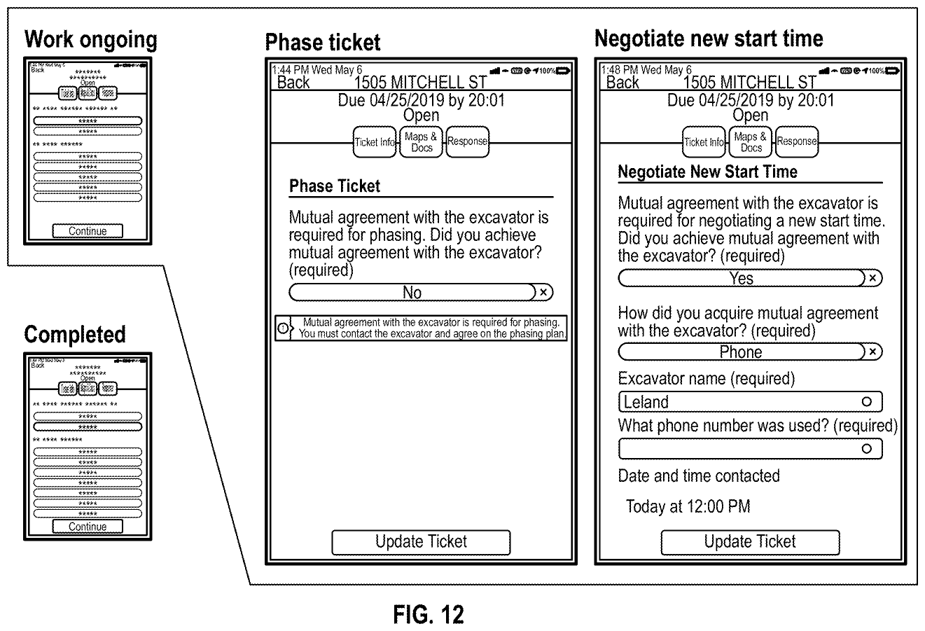

In some embodiments, the system is configured to generate built-in controls and “dynamic required fields” enabling and/or reinforcing standard work. For example, FIG. 12 illustrates example locate forms generated by the location and marking system according to some embodiments. In some embodiments, the forms include, but are not limited to, one or more of: a work on-ongoing form, a completed form or display, a phase ticket, and/or a phase ticket with features enabling a user to negotiate a new start time for the ticket and/or one or more work procedures of the ticket.

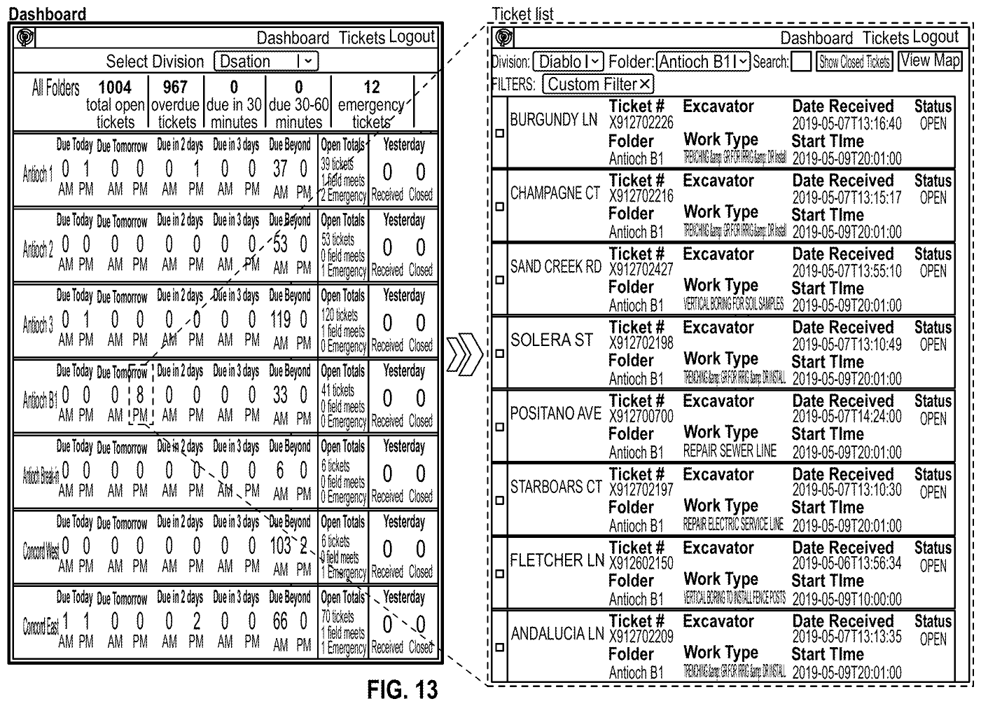

In some embodiments, the system is configured to generate data displays providing certain users (e.g., managers or supervisors) a holistic view of folders, including an ability to rapidly view individual ticket details. For example, FIG. 13 illustrates supervisor user interface functions generated by the location and marking system according to some embodiments. In some embodiments, the user interface can include a display of ticket statistics, including, but not limited to, one or more of: total open tickets, overdue tickets, tickets due today, due tomorrow, due in two days, due in three days, and/or due beyond; and/or open tickets including field meets, emergency, and/or tickets received yesterday including those received and/or closed. In some embodiments, the system is configured to enable the user to click or access any statistic to provide an expanded ticket or ticket list display. Further, in some embodiments, the system is configured to enable the user to click or access any ticket in the ticket list, or any details of the ticket to further display underlying or related information.

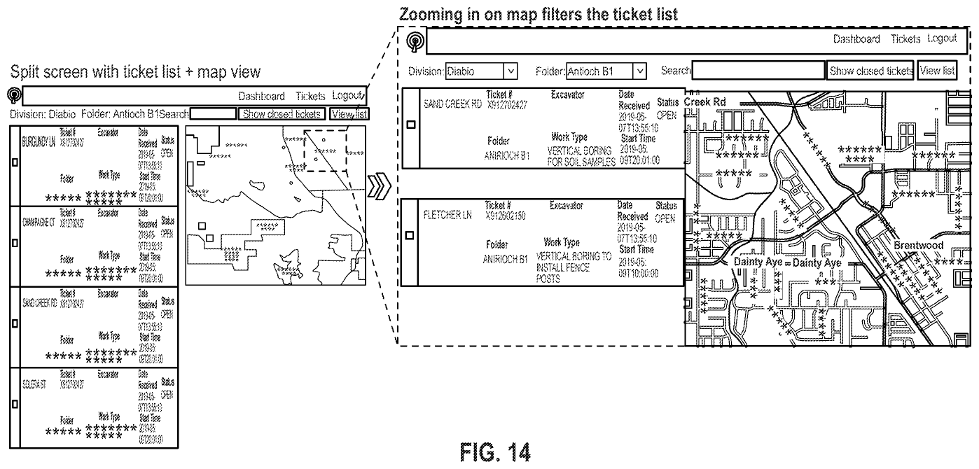

In some embodiments, the system is configured to enable a split screen display view allowing users to review both ticket and map details within a single display or portion of the display. For example, FIG. 14 illustrates a ticket-list split screen generated by the location and marking system according to some embodiments. In some embodiments, the system is configured to enable the user to click or access any statistic of a ticket and/or a portion of a map to provide an expanded ticket or ticket list display. Further, in some embodiments, the system is configured to enable the user to click, access, and/or use a zoom feature for any ticket in the ticket list, details of the ticket, and/or any mapped ticket to further display underlying or related information.

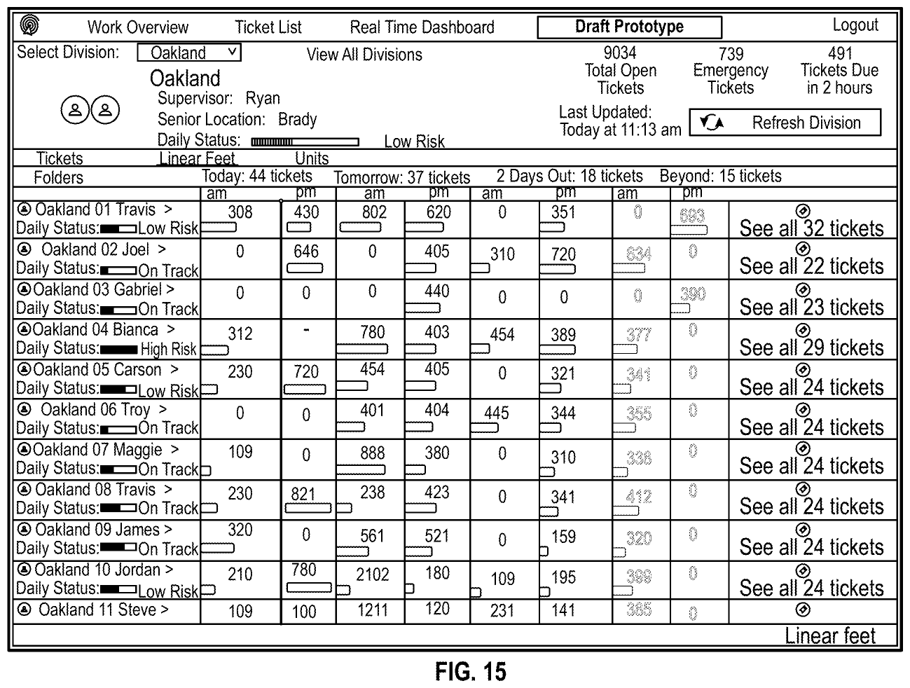

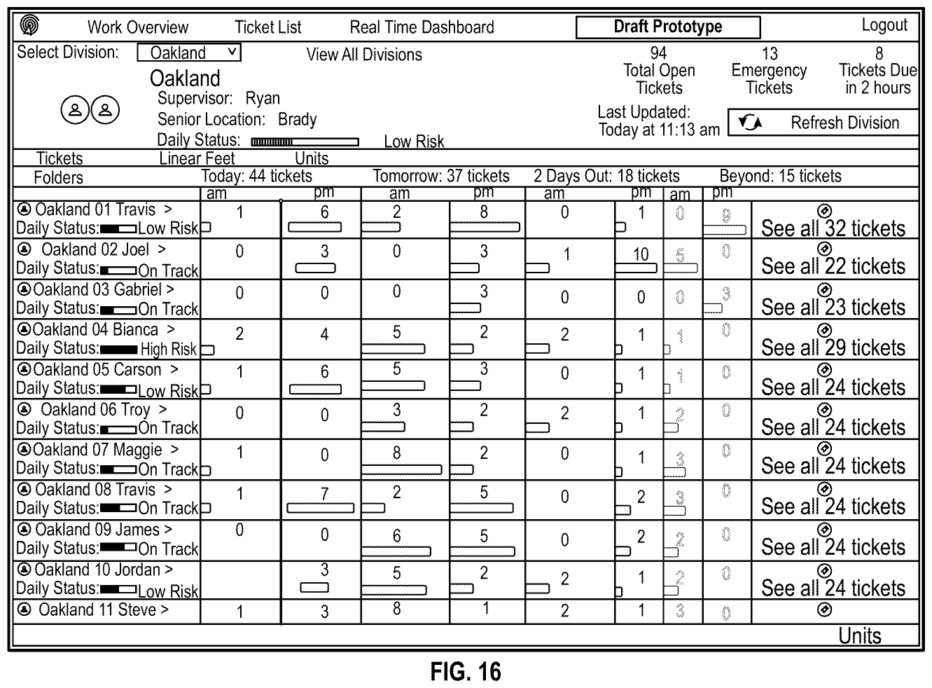

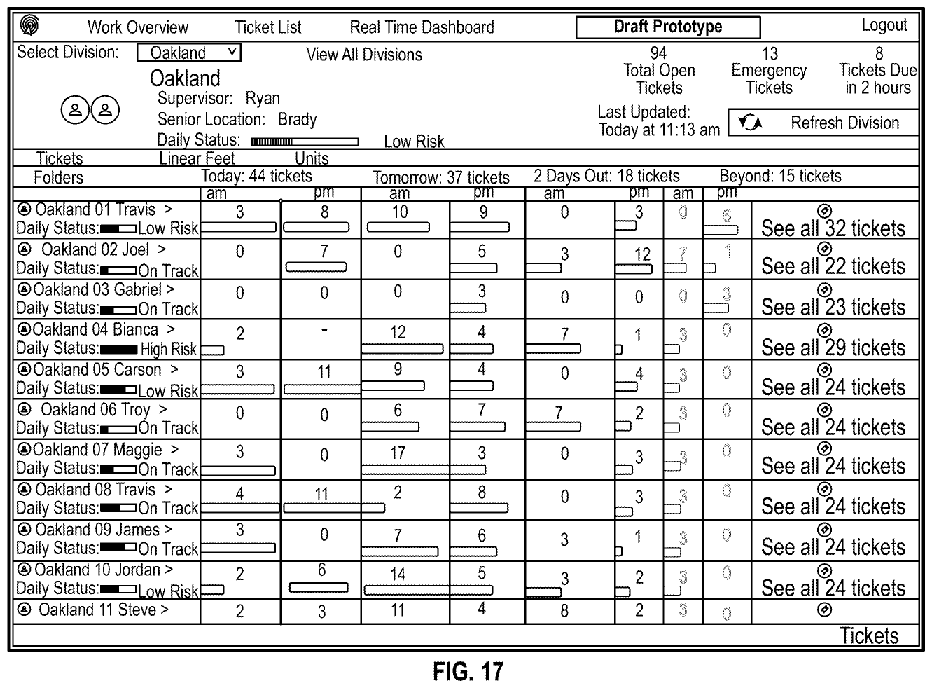

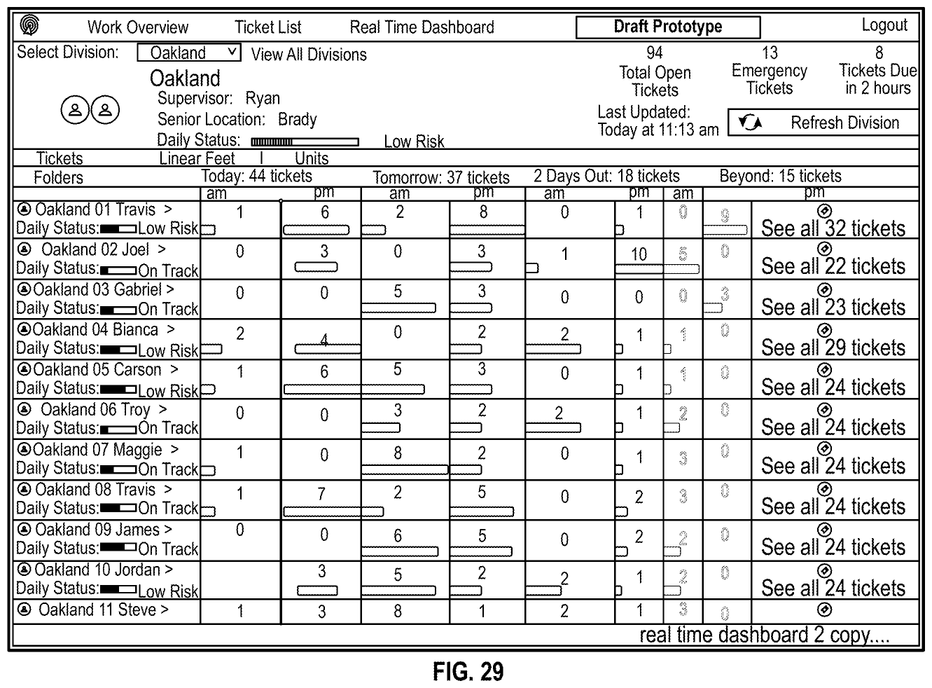

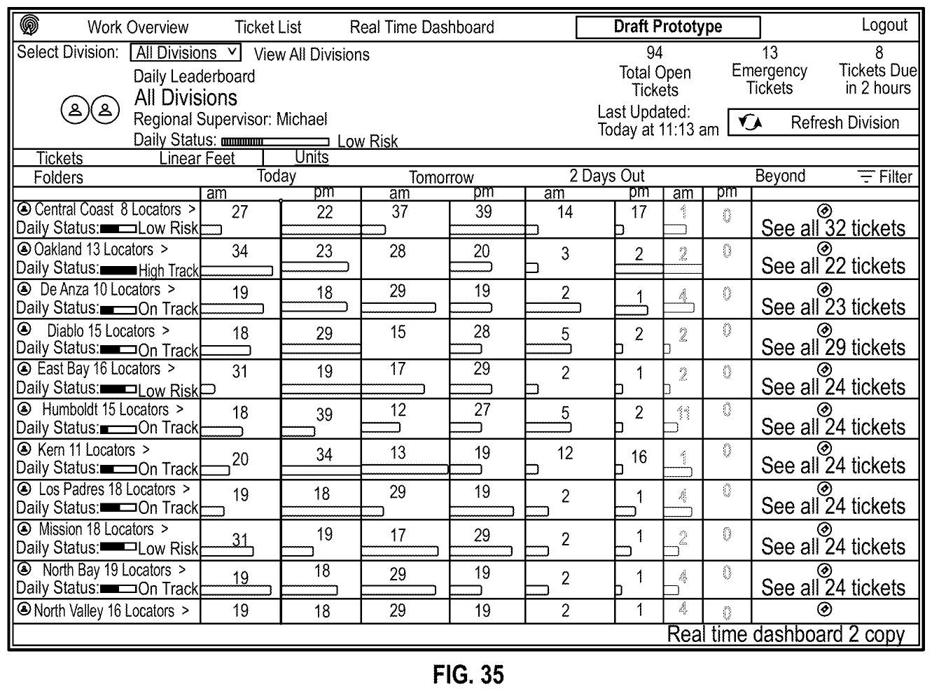

In some embodiments, the system is configured to generate dashboard display of tickets filtered by division, linear feet, and/or units. For example, FIGS. 15-17, 29, and 35 illustrate real-time dashboard displays generated by the location and marking system according to some embodiments. In some embodiments, the display includes a ticket list with ticket statistics for today, tomorrow, two days out, and beyond; and/or the user is able to view all tickets, and/or total open tickets, emergency tickets, and/or tickets due in two hours.

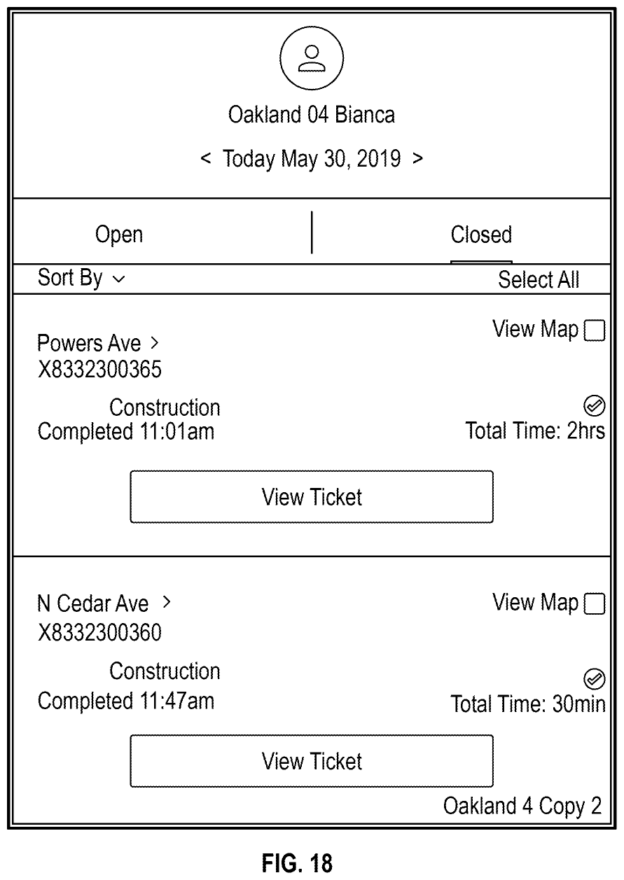

In some embodiments, the system is configured to displayed and/or scroll a ticket or list of tickets. For example, FIG. 18 illustrates a ticket list display generated by the location and marking system according to some embodiments. In some embodiments, the system is configured to enable the user to view the ticket on a map and/or view open or closed ticket details.

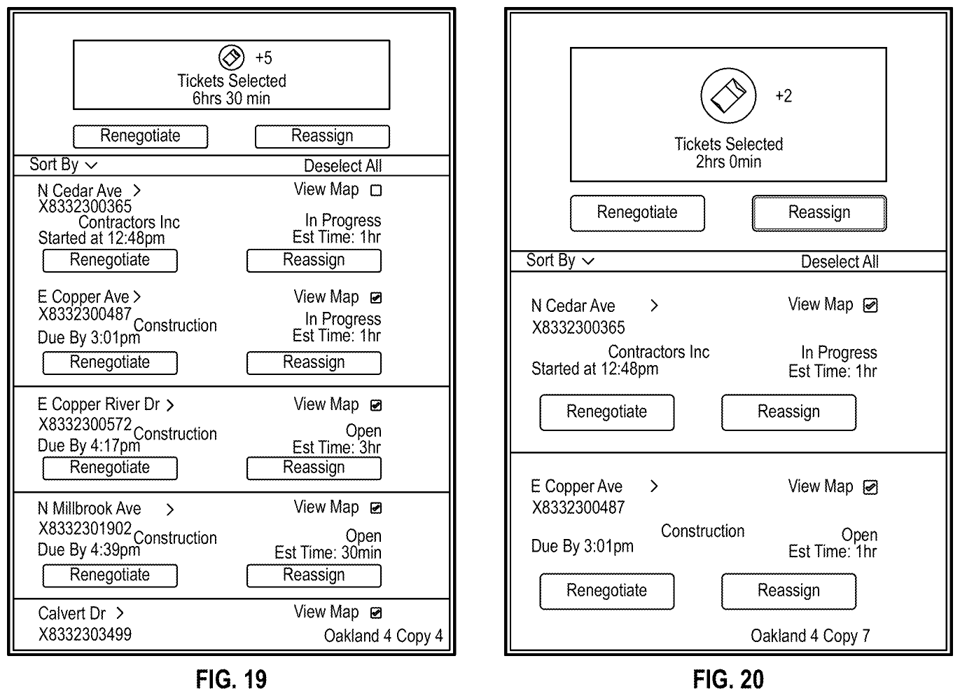

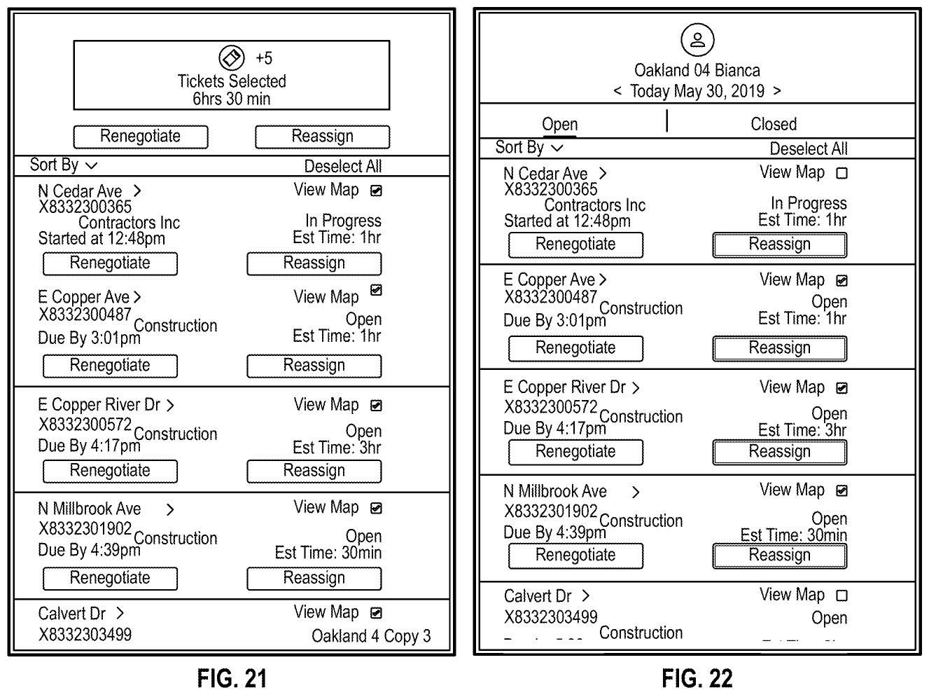

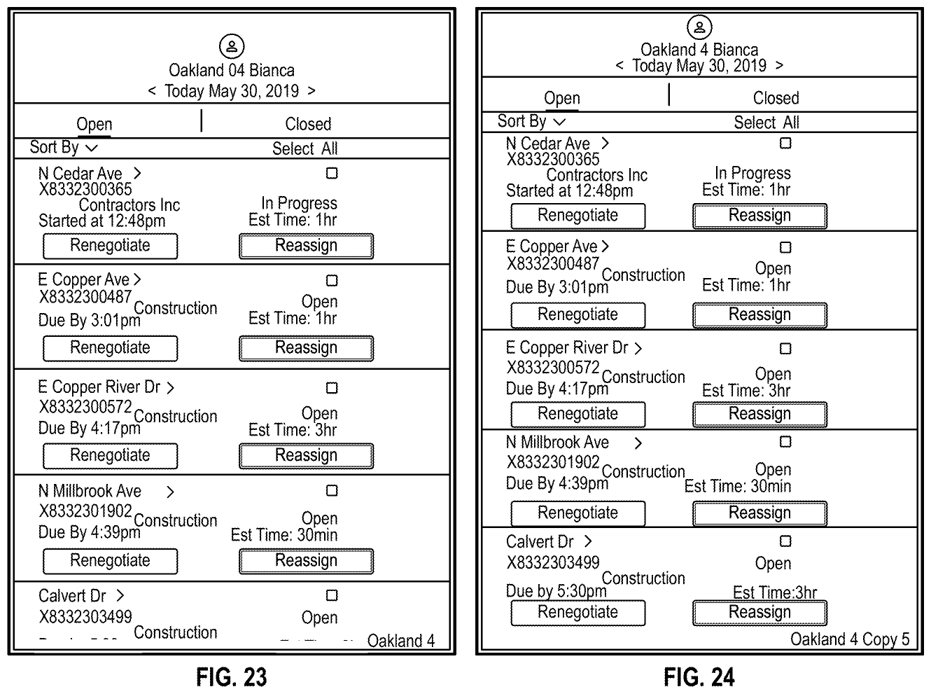

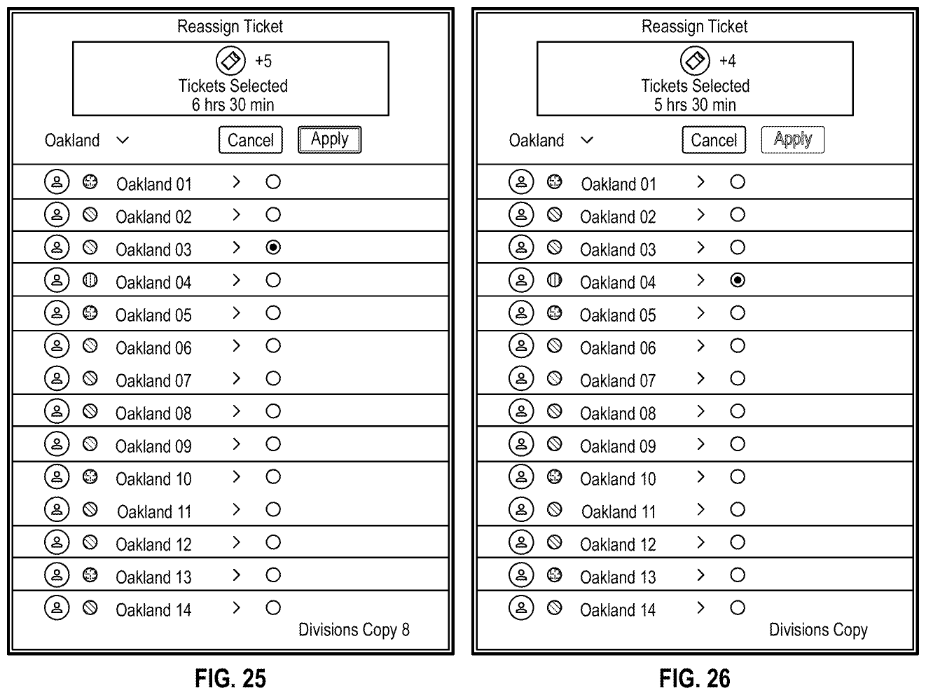

In some embodiments, the display includes lists of selectable tickets including selection options for opening, closing, reassigning, and/or renegotiating. For example, FIGS. 19-24 illustrate ticket selected displays generated by the location and marking system according to some embodiments, and FIGS. 25-26 illustrate reassign ticket displays generated by the location and marking system according to some embodiments.

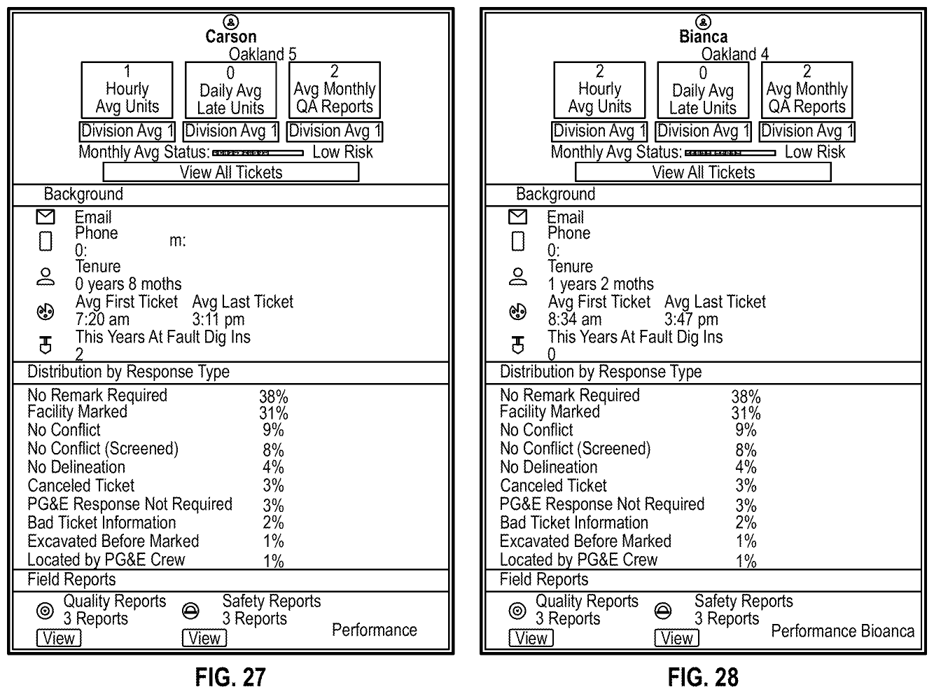

In some embodiments, the system is configured to display ticket statistics for individual users or employees. For example, FIGS. 27-28 illustrate performance display pages generated by the location and marking system according to some embodiments. In some embodiments, the displays include distribution by response type, access to quality or field reports and data, a risk assessment, and unit statistics.

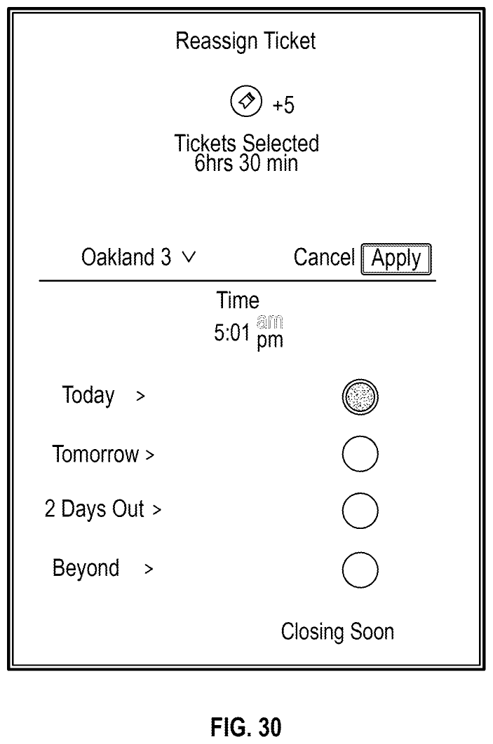

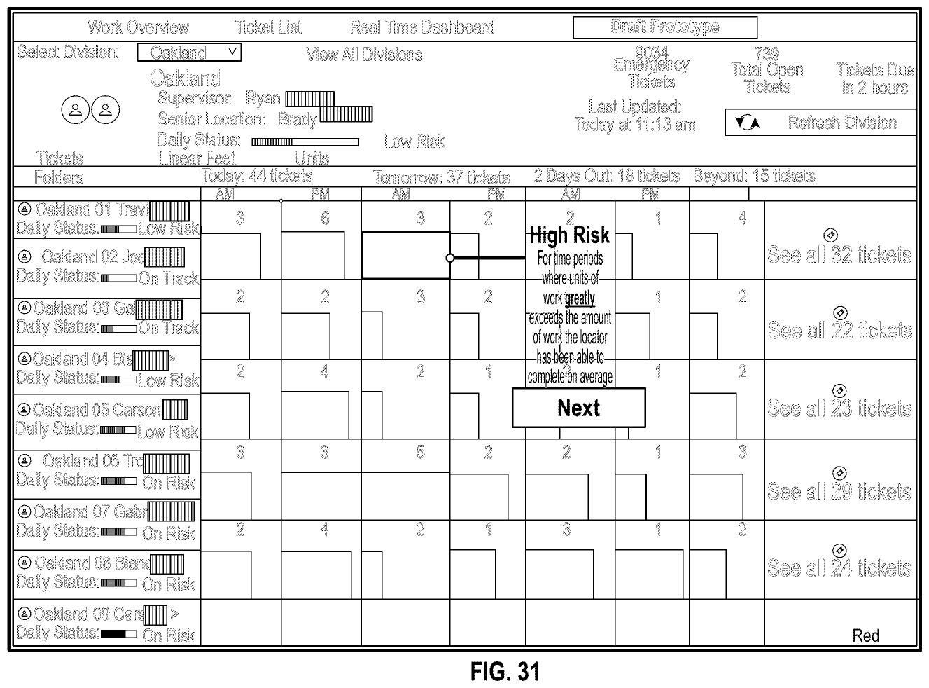

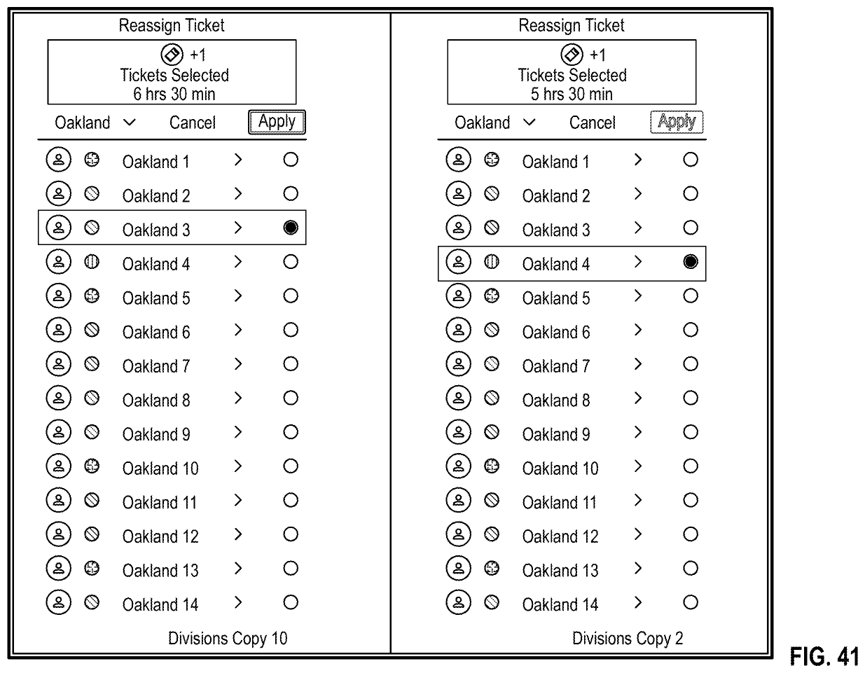

FIGS. 30 and 41 illustrate reassign ticket display generated by the location and marking system according to some embodiments. In some embodiments, the system is configured to enable ticket reassignment for a selected ticket, with reassignment time and/or date options.

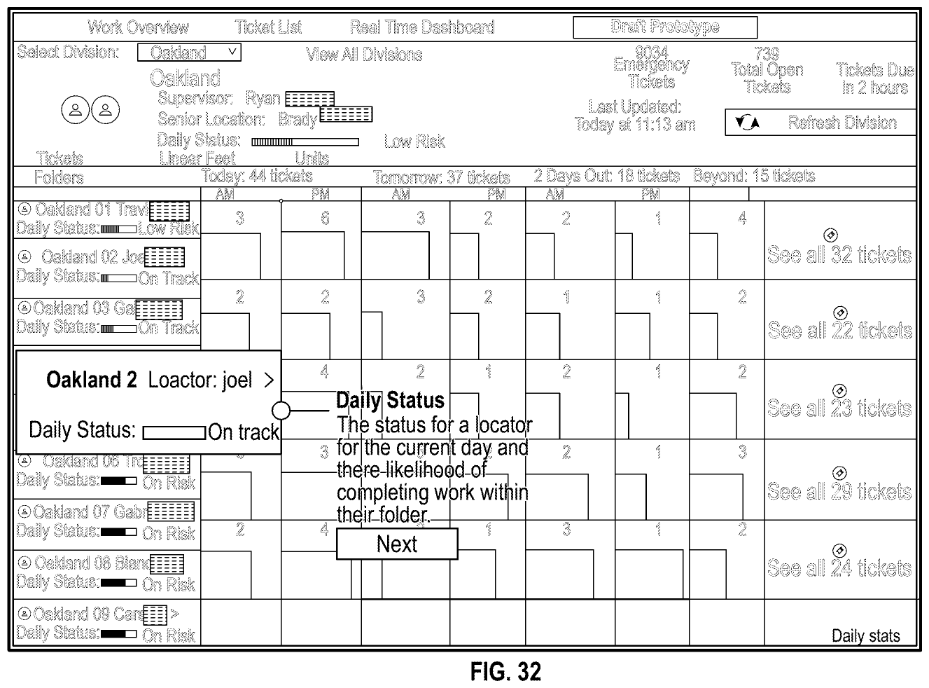

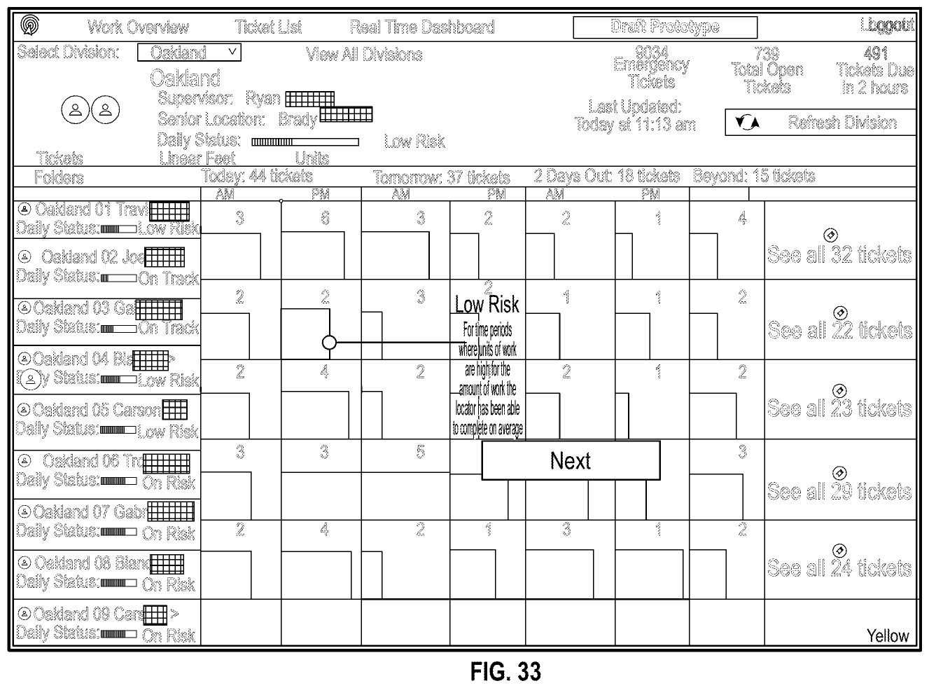

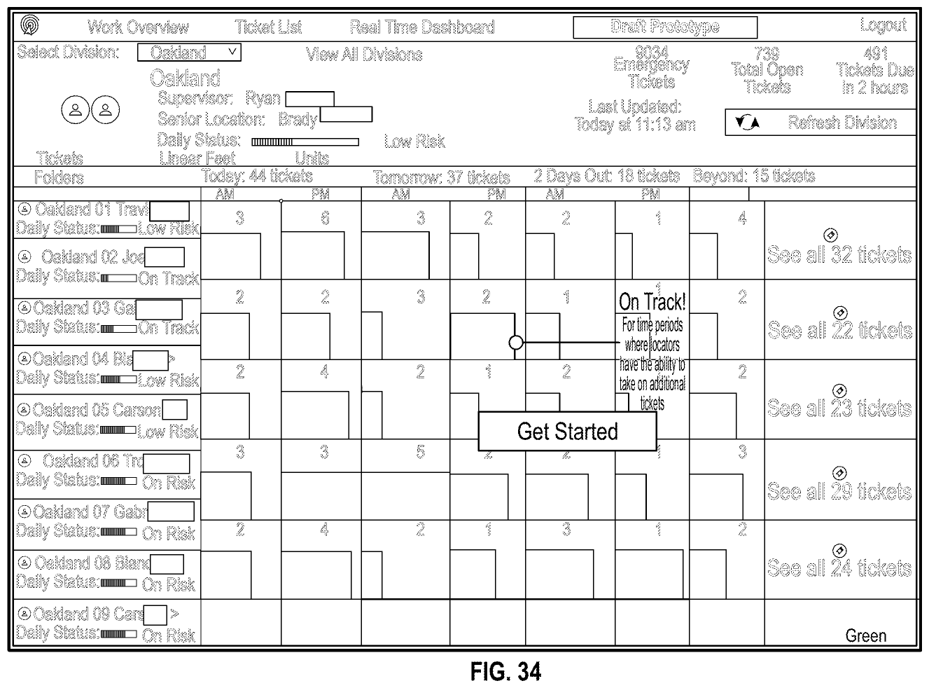

FIGS. 31-34 illustrate active real-time dashboard displays generated by the location and marking system according to some embodiments. In some embodiments, the display is configured to illustrate elevated risk time periods, a daily status indicator including an indication of likelihood of work completion, and/or an indicator of low or high-risk periods when units of work for the amount of work the locator has completed on average, and/or an on-track indicator for time periods where locations have the ability to take on additional work.

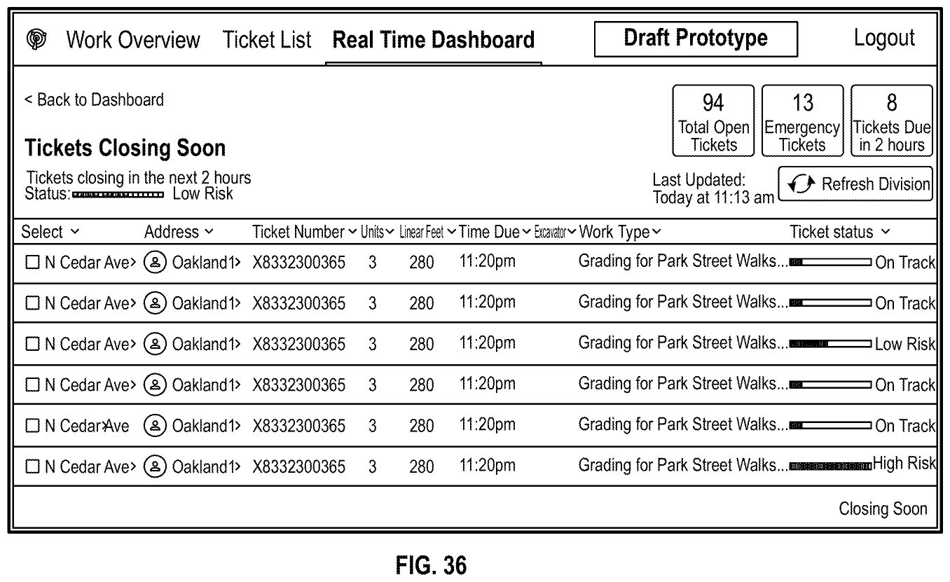

FIG. 36 illustrates a real-time dashboard display showing tickets closing soon, according to some embodiments. In some embodiments, the display is configured to include the address, ticket number, units, linear feet, time due, excavator, work type, and ticket status information.

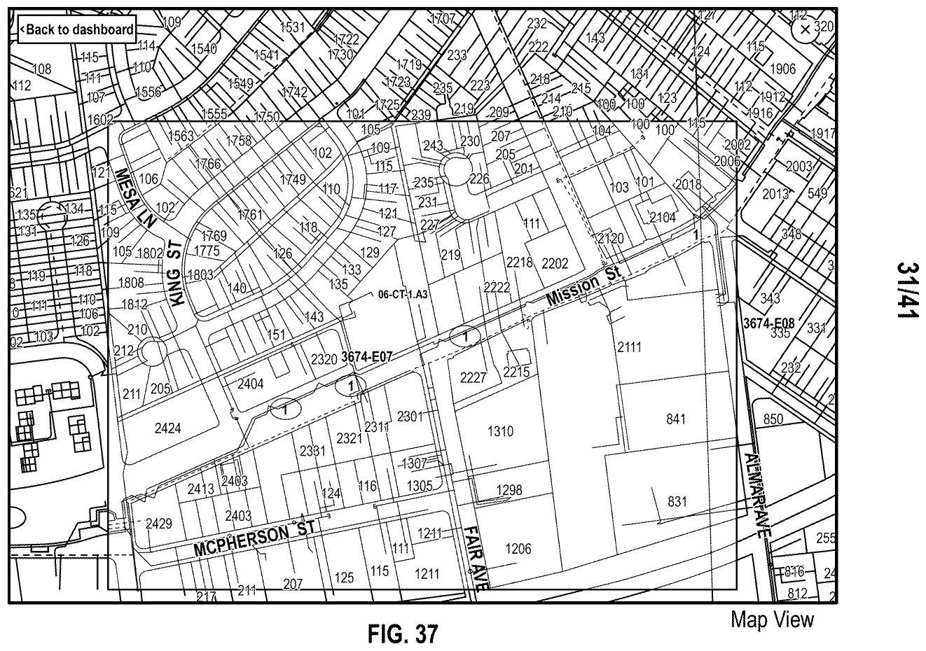

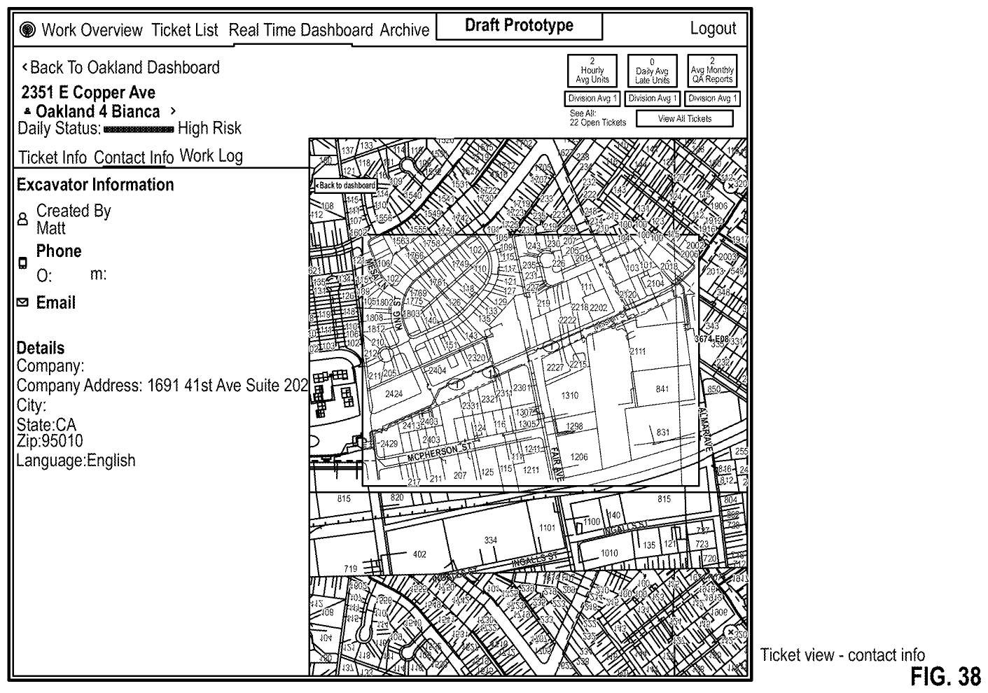

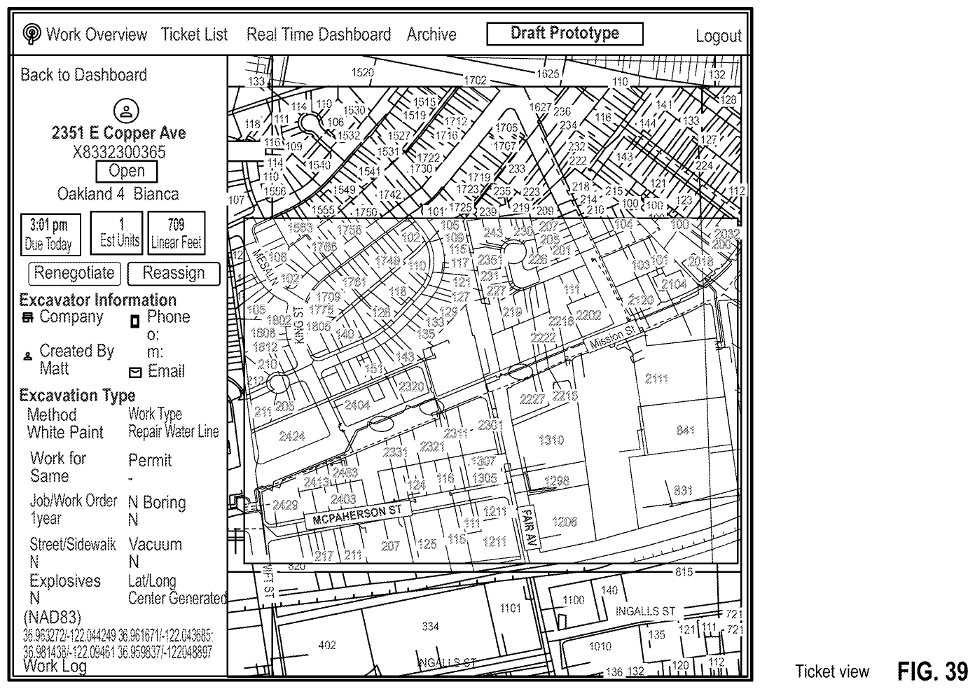

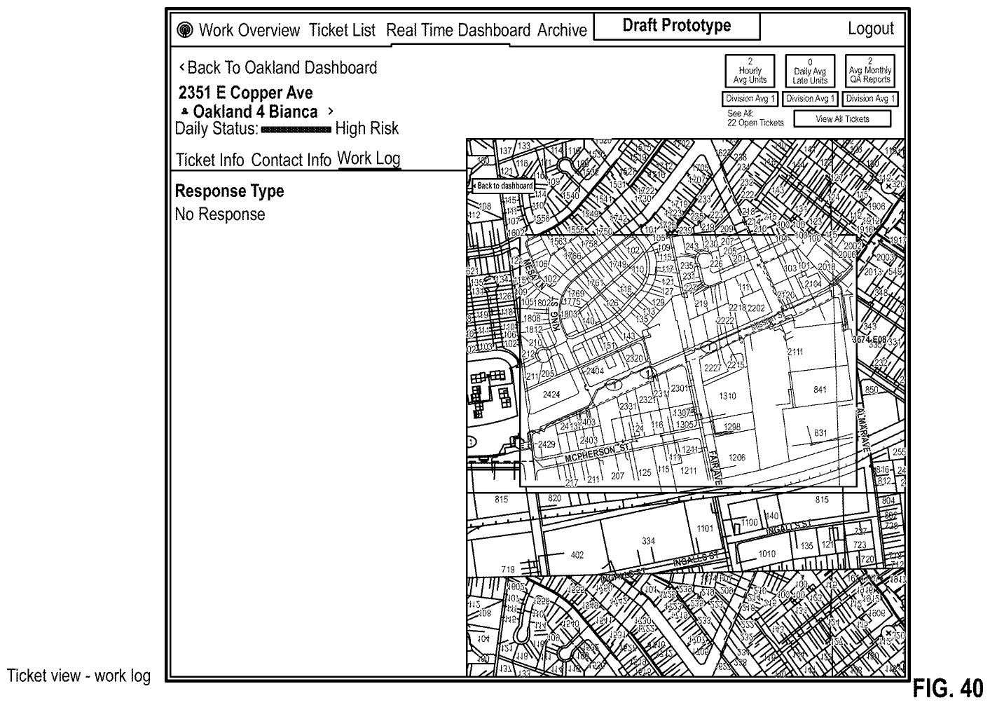

In some embodiments, the system is configured to allow the user to switch to a map view of an area as illustrated in FIG. 37, showing a map view display generated by the location and marking system according to some embodiments. Further, in some embodiments, the system is configured to display a map view and ticket information shown in the map view. For example, FIG. 38 illustrates a ticket view display generated by the location and marking system according to some embodiments; and FIGS. 39-40 illustrate ticket and map displays generated by the location and marking system according to some embodiments.

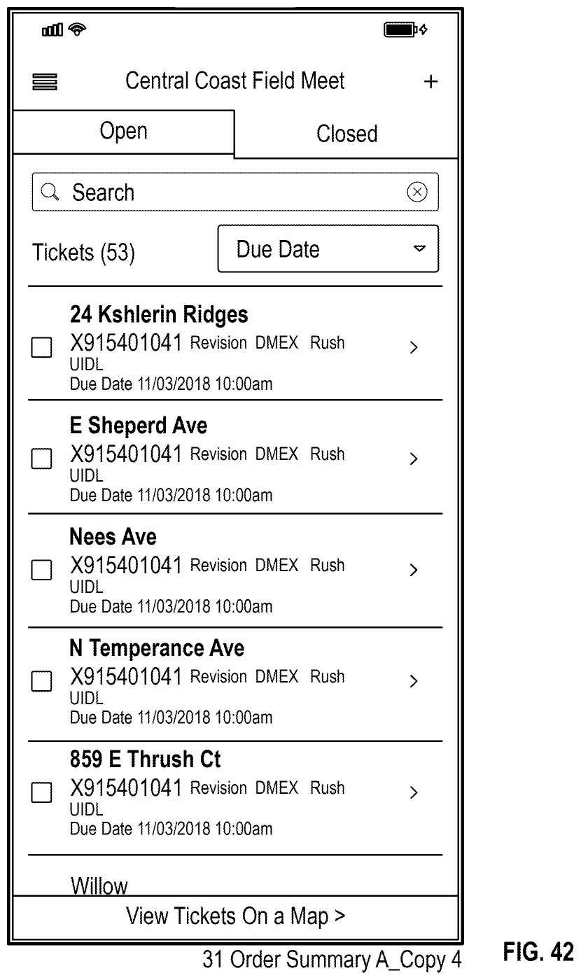

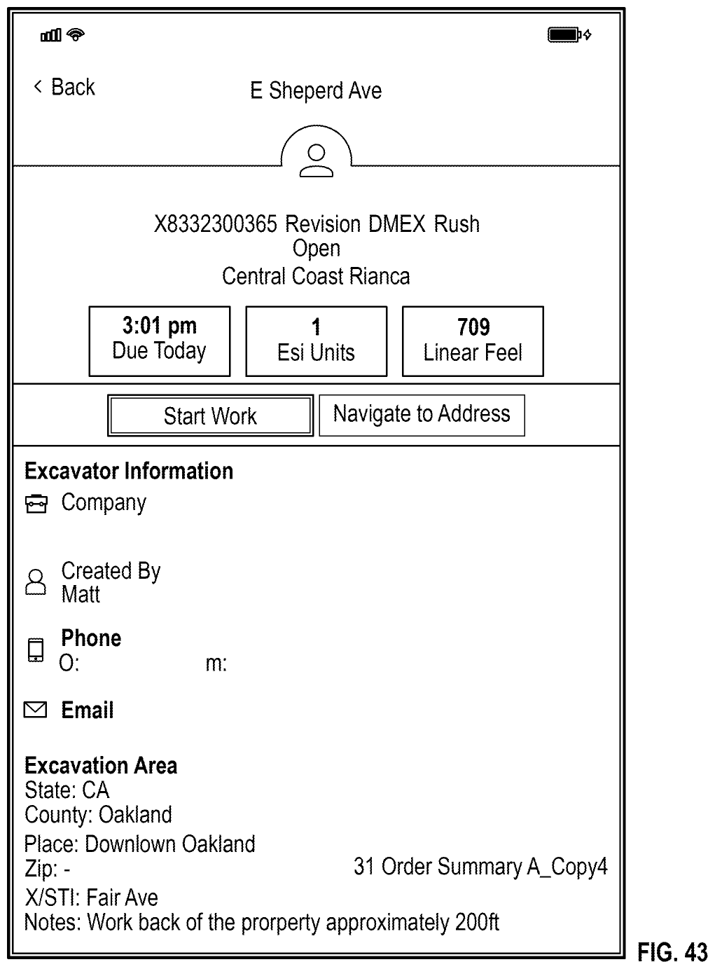

FIG. 42 illustrates an order summary display generated by the location and marking system according to some embodiments. In some embodiments, the system is configured to enable users to view an order summary of one or more tickets by filtering by one or more of due date, closed and/or open, and/or by a search for one or more tickets. In some embodiments, the system is configured to initiate a ticket detail display by clicking or accessing one or more tickets. For example, FIG. 43 illustrates a ticket and order detail display generated by the location and marking system according to some embodiments. In some embodiments, the system is configured to enable the user to start the work from the display and/or navigate to the address of the ticket.

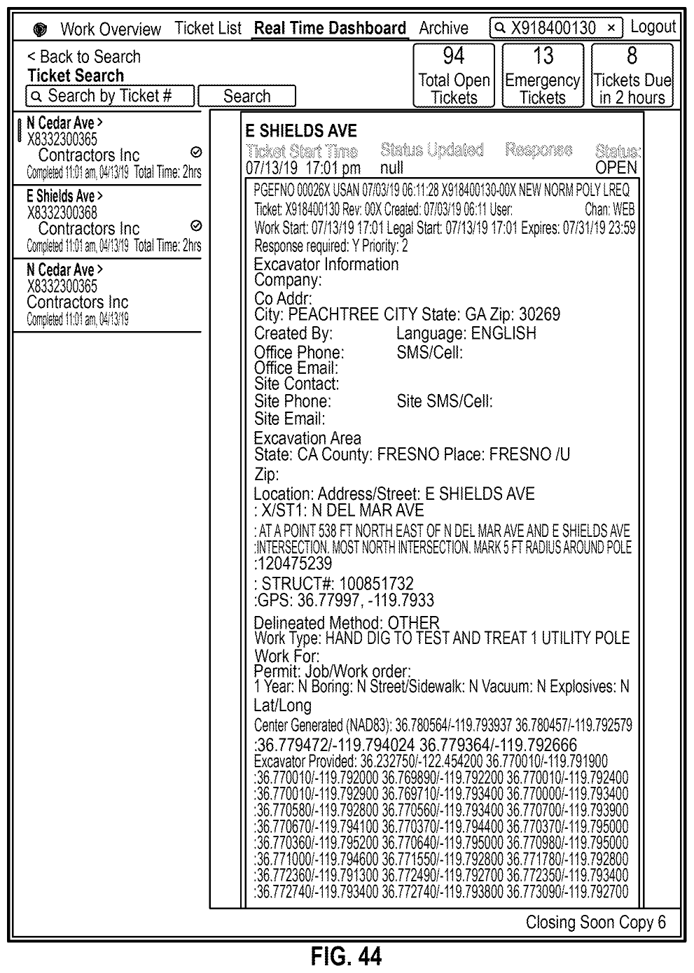

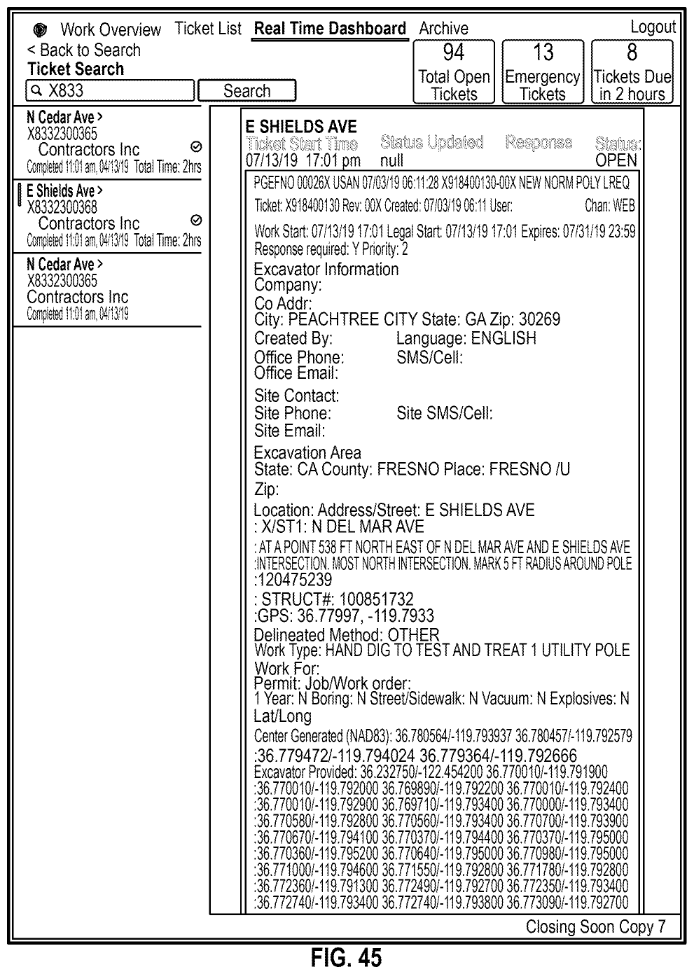

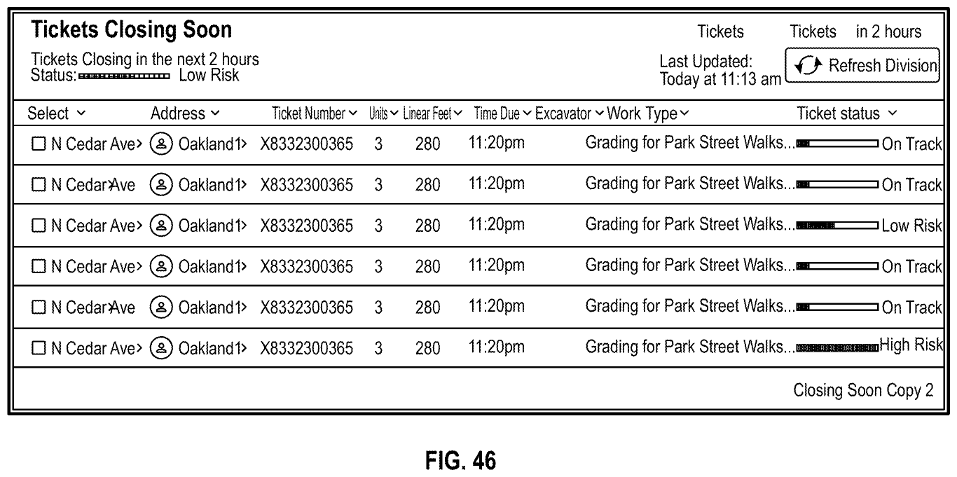

In some embodiments, the system is configured to enable users to search for closing soon tickets. For example, FIGS. 44-45 illustrate closing soon displays generated by the location and marking system according to at least one embodiment of the invention. Further, FIG. 46 illustrates a “tickets closing soon” list display generated by the location and marking system according to some embodiments.

In some embodiments, the system can be optimized for use on a mobile phone (e.g., an Apple iPhone®). In some embodiments, the system is configured to enable any of the functions of the system across multiple devices substantially simultaneously (“substantially simultaneously” is defined as simultaneous execution of programs that also includes inherent process and/or network latency and/or prioritizing of computing operations). Some embodiments include improved methods for better tracking work start and stop time. Some embodiments include location-based geo-fencing. Some embodiments include auto-notifications to one or more “DIRT” teams for select field situations (e.g., when the locator closes ticket as “Excavated before marked”). Some embodiments include enhanced auto-processing of tickets where locators don't need to work (e.g. when excavators cancel tickets).

Some embodiments include bulk actioning of tickets in mobile applications, enabled in a web interface in some embodiments, that is configured to allow a single response to multiple tickets. Some embodiments include refined reports that focus on data that is most meaningful to the business. Some embodiments include the ability to generate “break-in” tickets and work items (e.g., to track activity for internal, non-811 ticket locating work). Some embodiments include bread-crumbing of locator geo-location (to understand real time and past location for safety, performance, and work planning). Some embodiments include identification of marked delineation in-application (to clarify real work vs. 811 polygon and serve as input for unitization). In some embodiments, the system includes accessible in Maps+ (e.g., building on already-completed integration of GSRs into Maps+). Some further embodiments include tracking of specific hook-up points to support unitization and provide useful information for future locates at same site. Some embodiments include routing support for optimized driving route based on work. Apple iPhone® is a registered trademark of Apple Inc.

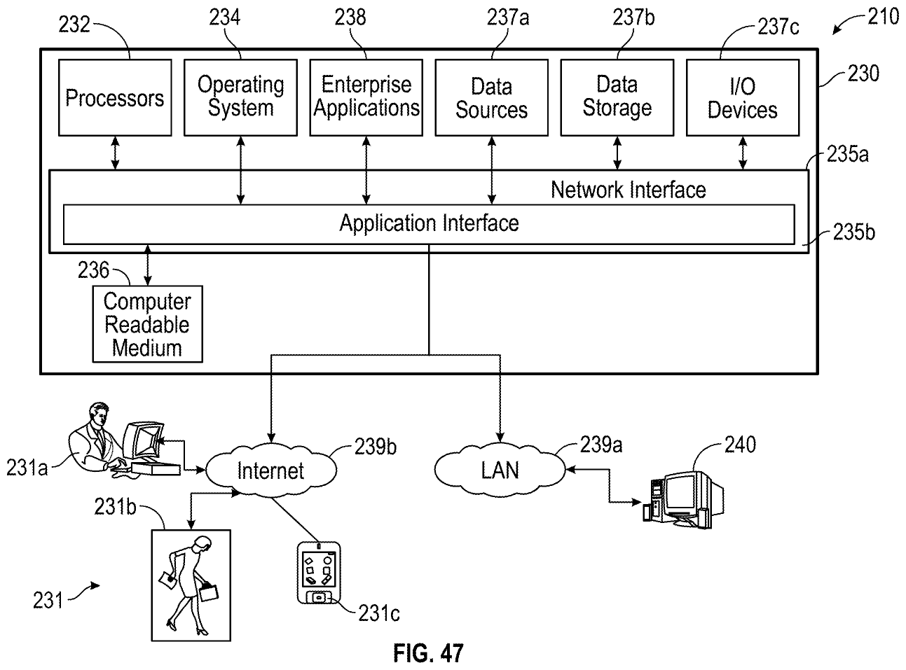

FIG. 47 illustrates a computer system enabling systems and methods in accordance with some embodiments. In some embodiments, the computer system 210 is configured to include and/or operate and/or process computer-executable code of one or more of the above-mentioned program logic, software modules, and/or systems. Further, in some embodiments, the computer system 210 is configured to operate and/or display information within one or more graphical user interfaces. In some embodiments, the computer system 210 comprises a cloud server and/or is configured to be coupled to one or more cloud-based server systems.

In some embodiments, the system 210 comprises at least one computing device including at least one processor 232. In some embodiments, the at least one processor 232 can include a processor residing in, or coupled to, one or more server platforms. In some embodiments, the system 210 can include a network interface 235a and an application interface 235b coupled to the least one processor 232 capable of processing at least one operating system 234. Further, in some embodiments, the interfaces 235a, 235b coupled to at least one processor 232 can be configured to process one or more of the software modules 238 (e.g., such as enterprise applications). In some embodiments, the software modules 238 can include server-based software, and operate to host at least one user account and/or at least one client account, and operate to transfer data between one or more of these accounts using the at least one processor 232.

With the above embodiments in mind, it should be understood that the invention can employ various computer-implemented operations involving data stored in computer systems. Moreover, in some embodiments, the above-described databases and models described throughout can store analytical models and other data on computer-readable storage media within the system 210 and on computer-readable storage media coupled to the system 210. In addition, in some embodiments, the above-described applications of the system is configured to be stored on computer-readable storage media within the system 210 and/or on computer-readable storage media coupled to the system 210. In some embodiments, these operations are those requiring physical manipulation of physical quantities. Usually, though not necessarily, in some embodiments, these quantities take the form of electrical, electromagnetic, or magnetic signals, optical or magneto-optical form capable of being stored, transferred, combined, compared and otherwise manipulated. In some embodiments, the system 210 comprises at least one computer readable medium 236 coupled to at least one data source 237a, and/or at least one data storage device 237b, and/or at least one input/output device 237c.

In some embodiments, the invention is embodied as computer readable code on a computer readable medium 236. In some embodiments, the computer readable medium 236 is any data storage device that can store data, which can thereafter be read by a computer system (such as the system 210). In some embodiments, the computer readable medium 236 is any physical or material medium that can be used to tangibly store the desired information or data or instructions and which can be accessed by a computer or processor 232.

In some embodiments, the computer readable medium 236 includes hard drives, network attached storage (NAS), read-only memory, random-access memory, FLASH based memory, CD-ROMs, CD-Rs, CD-RWs, DVDs, magnetic tapes, other optical and non-optical data storage devices. In some embodiments, various other forms of computer-readable media 236 transmit or carry instructions to a computer 240 and/or at least one user 231, including a router, private or public network, or other transmission device or channel, both wired and wireless. In some embodiments, the software modules 238 is configured to send and receive data from a database (e.g., from a computer readable medium 236 including data sources 237a and data storage 237b that comprises a database), and data is received by the software modules 238 from at least one other source. In some embodiments, at least one of the software modules 238 is configured within the system to output data to at least one user 231 via at least one graphical user interface rendered on at least one digital display.

In some embodiments, the computer readable medium 236 is distributed over a conventional computer network via the network interface 235a where the system embodied by the computer readable code can be stored and executed in a distributed fashion. For example, in some embodiments, one or more components of the system 210 is configured to send and/or receive data through a local area network (“LAN”) 239a and/or an internet coupled network 239b (e.g., such as a wireless internet). In some further embodiments, the networks 239a, 239b are configured to include wide area networks (“WAN”), direct connections (e.g., through a universal serial bus port), and/or other forms of computer-readable media 236, and/or any combination thereof.

In some embodiments, components of the networks 239a, 239b include any number of user devices such as personal computers including for example desktop computers, and/or laptop computers, and/or any fixed, generally non-mobile internet appliances coupled through the LAN 239a. For example, some embodiments include personal computers 240a coupled through the LAN 239a that can be configured for any type of user including an administrator. Some embodiments include personal computers coupled through network 239b. In some further embodiments, one or more components of the system 210 are coupled to send or receive data through an internet network (e.g., such as network 239b).

For example, some embodiments include at least one user 231 coupled wirelessly and accessing one or more software modules of the system including at least one enterprise application 238 via an input and output (“I/O”) device 237c. In some other embodiments, the system 210 can enable at least one user 231 to be coupled to access enterprise applications 238 via an I/O device 237c through LAN 239a. In some embodiments, the user 231 can comprise a user 23 la coupled to the system 210 using a desktop computer, laptop computers, and/or any fixed, generally non-mobile internet appliances coupled through the internet 239b. In some further embodiments, the user 231 comprises a mobile user 23 lb coupled to the system 210. In some embodiments, the user 23 lb can use any mobile computing device 23 lc to wireless coupled to the system 210, including, but not limited to, personal digital assistants, and/or cellular phones, mobile phones, or smart phones, and/or pagers, and/or digital tablets, and/or fixed or mobile internet appliances.

Acting as Applicant's own lexicographer, Applicant defines the use of and/or, in terms of “A and/or B,” to mean one option could be “A and B” and another option could be “A or B.” Such an interpretation is consistent with the USPTO Patent Trial and Appeals Board ruling in ex parte Gross, where the Board established that “and/or” means element A alone, element B alone, or elements A and B together.

Some embodiments of the system are presented with specific values and/or setpoints. These values and setpoints are not intended to be limiting, and are merely examples of a higher configuration versus a lower configuration and are intended as an aid for those of ordinary skill to make and use the system. In addition, “substantially” and “approximately” when used in conjunction with a value encompass a difference of I 0% or less of the same unit and scale of that being measured. In some embodiments, “substantially” and “approximately” are defined as presented in the specification.

It is understood that the system is not limited in its application to the details of construction and the arrangement of components set forth in the previous description or illustrated in the drawings. The system and methods disclosed herein fall within the scope of numerous embodiments. The previous discussion is presented to enable a person skilled in the art to make and use embodiments of the system. Modifications to the illustrated embodiments and the generic principles herein can be applied to all embodiments and applications without departing from embodiments of the system. Also, it is understood that features from some embodiments presented herein are combinable with other features according to some embodiments. Thus, some embodiments of the system are not intended to be limited to what is illustrated but are to be accorded the widest scope consistent with all principles and features disclosed herein.

1-20. (canceled)

21. A system comprising:
one or more computers comprising one or more processors and one or more non-transitory computer readable media, the one or more non-transitory computer readable media including program instructions stored thereon that when executed cause the one or more computers to:
generate, by the one or more processors, one or more maps on a graphical user interface;
automatically generate, by the one or more processors, one or more tickets on the graphical user interface;
display, by the one or more processors, the one or more maps on the graphical user interface, the display including a representation of one or more assets on the one or more maps based at least in part on an actual physical location of the one or more assets;
display, by the one or more processors, the one or more tickets and the representation of the one or more assets on at least one of the one or more maps;
display, by the one or more processors, a selection of a plurality of map types on the graphical user interface, each of the plurality of map types comprising a different infrastructure type of each of the one or more assets;
receive, by the one or more processors, the selection of at least one of the plurality of map types from the graphical user interface; and
display, by the one or more processors, the selection on the graphical user interface.

22. The system of claim 21,
wherein the different infrastructure type include one or more of gas distribution, gas transmission, electrical distribution, electrical transmission, hydroelectrical infrastructure, sewer infrastructure, underground infrastructure, and fiber infrastructure.

23. The system of claim 22,
wherein the graphical user interface is configured to display ticket statistics.

24. The system of claim 23,
wherein the system is configured to allow a user to select an active division.

25. The system of claim 24,
the graphical user interface is configured to automatically display tickets filtered by division.

26. The system of claim 21,
wherein the graphical user interface is configured to enable an entry of ticket information.

27. The system of claim 21,
wherein the graphical user interface is configured to enable a user to select a portion of the one or more maps to display an expanded ticket.

28. The system of claim 21,
wherein the graphical user interface is configured to enable a user to view ticket details on the one or more maps.

29. The system of claim 21,
wherein the graphical user interface is configured to display tickets of a selected division on one side of the display and a map of at least a portion of the selected division on an opposite side of the display.

30. The system of claim 29,
wherein the graphical user interface is configured to enable a user to execute a start work command from the display.

31. The system of claim 21,
wherein the system includes location-based geo-fencing.

32. The system of claim 21,
wherein the graphical user interface includes one or more selection options for one or more of opening, closing, reassigning, and renegotiating the one or more tickets.

33. The system of claim 21,
wherein the system is configured to filter maps by division; and
wherein filtering the maps by division enables a selective display of a portion of the one or more assets on the graphical user interface.

34. The system of claim 21,
wherein the graphical user interface is configured to enable a single response to multiple tickets.

35. The system of claim 21,
wherein the graphical user interface includes one or more forms.

36. The system of claim 35,
wherein the one or more forms include an ongoing work form.

37. The system of claim 21,
wherein the graphical user interface is configured to display a ticket list and a map search simultaneously.

38. The system of claim 21,
wherein the graphical user interface is configured to automatically and simultaneously display a ticket list and a map search.

39. The system of claim 21,
wherein the graphical user interface is configured to filter the one or more maps by division.

40. The system of claim 39,
wherein filtering the one or more maps by division enables a user to selectively display a portion of the one or more assets.
